(19) United States
(12) Patent Application Publication
(10) Pub. No.: US 2025/0078293 A1
(43) Pub. Date: Mar. 6, 2025

(54) MEDICAL IMAGE REGISTRATION METHOD, COMPUTER APPARATUS AND STORAGE MEDIUM

(71) Applicant: Shanghai United Imaging Healthcare Co., Ltd., Shanghai (CN)

(72) Inventors: Chen Sun, Shanghai (CN); Yihuan Lu, Shanghai (CN); Yun Dong, Shanghai (CN)

(21) Appl. No.: 18/817,327

(22) Filed: Aug. 28, 2024

(30) Foreign Application Priority Data
Aug. 28, 2023 (CN) 202311094119.5
Dec. 21, 2023 (CN) 202311775725.3
Dec. 21, 2023 (CN) 202311778630.7

(51) Int. Cl. G06T 7/33; G06T 7/11; G06T 7/187; G06T 7/32; G06T 7/35

(52) U.S. Cl. CPC G06T 7/337; G06T 7/11; G06T 7/187; G06T 7/32; G06T 7/35; G06T 2207/10104; G06T 2207/20021; G06T 2207/20081; G06T 2207/30004

(57) ABSTRACT

The present disclosure relates to a medical image registration method, a computer apparatus and a storage medium. The method includes: obtaining a similarity weight distribution containing a similarity weight of each element; adjusting, based on the similarity weight of each element, a contribution of a corresponding element in a similarity term of a loss function to the loss function; the similarity weight of the element having a positive correlation relationship with a registration requirement accuracy associated with a region in which the element is located; obtaining, based on an optimized loss function obtained by the adjustment, a target deformation field.

### CROSS-REFERENCE TO RELATED APPLICATIONS

The present application claims priority to Chinese patent application No. 202311094119.5, titled “ATTENUATION COEFFICIENT IMAGE PROCESSING METHOD AND DEVICE, COMPUTER APPARATUS AND STORAGE MEDIUM”, filed on Aug. 28, 2023, Chinese patent application No. 202311778630.7, titled “MEDICAL IMAGE REGISTRATION METHOD AND DEVICE, APPARATUS AND STORAGE MEDIUM”, filed on Dec. 21, 2023, and Chinese patent application No. 202311775725.3, titled “METHOD AND DEVICE FOR IMAGE REGISTRATION BASED ON PET IMAGE, AND APPARATUS”, filed on Dec. 21, 2023. The contents of the above identified Chinese patent applications are incorporated herein in their entireties by reference for all purposes.

### TECHNICAL FIELD

The present disclosure relates to the field of image registration technologies, and in particular, to a medical image registration method, a computer apparatus and a storage medium.

### BACKGROUND

In medical image registration, iterative optimization or deep learning methods are generally used to optimize a deformation field between a reference image and a motion image to minimize a loss function. The loss function generally includes a similarity term that represents the similarity between the reference image and a deformed motion image.

In the related art, the similarity term used is generally space-independent. In other words, all elements are treated equally in the registration. However, since different regions in a medical image have different registration requirement accuracies, the conventional strategy is actually a relatively limited approach.

### SUMMARY

In a first aspect, the present disclosure provides a medical image registration method, including: determining a similarity term and a regularization term in an element-based loss function used for medical image registration; obtaining a similarity weight distribution and a regularization weight distribution; adjusting, based on a similarity weight of each element contained in the similarity weight distribution, a contribution of a corresponding element in the similarity term to the loss function, the similarity weight of the element having a positive correlation relationship with a registration requirement accuracy associated with a region in which the element is located; adjusting, based on a regularization weight of each element contained in the regularization weight distribution, a contribution of a corresponding element in the regularization term to the loss function, the regularization weight of the element having a negative correlation relationship with a degree of freedom of tissue deformation associated with a region in which the element is located; and obtaining, based on an optimized loss function obtained by the adjustment, a target deformation field.

In a second aspect, the present disclosure provides a medical image registration device, including: a loss function processing module configured to determine a similarity term and a regularization term in an element-based loss function used for medical image registration; a weight distribution obtaining module configured to obtain a similarity weight distribution and a regularization weight distribution; an adjustment module configured to: adjust, based on a similarity weight of each element contained in the similarity weight distribution, a contribution of a corresponding element in the similarity term to the loss function, the similarity weight of the element having a positive correlation relationship with a registration requirement accuracy associated with a region in which the element is located; and adjust, based on a regularization weight of each element contained in the regularization weight distribution, a contribution of a corresponding element in the regularization term to the loss function, the regularization weight of the element having a negative correlation relationship with a degree of freedom of tissue deformation associated with a region in which the element is located; and a deformation field obtaining module configured to obtain, based on an optimized loss function obtained by the adjustment, a target deformation field.

In a third aspect, the present disclosure provides a method for image registration based on a PET image. The method includes: selecting any one of a PET image and other medical image to perform a ROI segmentation to obtain ROIs, the other medical image being of the same or different modality as the PET image; determining, based on a size of the ROI in which a ROI element is located and a tracer concentration of the ROI element in the PET image, a similarity weight of each ROI element; determining a similarity term in an element-based loss function used for medical image registration, and adjusting, based on the similarity weight of each ROI element, a contribution of a corresponding element in the similarity term to the loss function to obtain an optimized loss function; and obtaining, based on the optimized loss function, a deformation field between the PET image and the other medical image.

In a fourth aspect, the present disclosure provides a device for image registration based on a PET image. The device includes: a region segmentation module configured to select any one of a PET image and other medical image to perform a ROI segmentation to obtain ROIs, the other medical image being of the same or different modality as the PET image; a similarity weight obtaining module configured to determine, based on a size of the ROI in which a ROI element is located and a tracer concentration of the ROI element in the PET image, a similarity weight of each ROI element; an adjustment module configured to determine a similarity term in an element-based loss function used for medical image registration, and adjust, based on the similarity weight of each ROI element, a contribution of a corresponding element in the similarity term to the loss function to obtain an optimized loss function; and a deformation field obtaining module configured to obtain, based on the optimized loss function, a deformation field between the PET image and the other medical image.

In a fifth aspect, the present disclosure provides an attenuation coefficient image processing method, including: dividing, based on attenuation coefficient values respectively corresponding to elements in an attenuation coefficient image, the elements into different attenuation coefficient intervals, the different attenuation coefficient intervals having different image contrasts; adjusting, based on mapping functions respectively corresponding to the attenuation coefficient intervals, the attenuation coefficient value of the element in at least one attenuation coefficient interval, a slope of the mapping function of the attenuation coefficient interval with a minimum image contrast being greater than a slope of the mapping function of other attenuation coefficient interval; and obtaining, based on adjusted attenuation coefficient values, a preprocessed image to be registered.

In a sixth aspect, the present disclosure provides an attenuation coefficient image processing device, including: a division module configured to divide, based on attenuation coefficient values respectively corresponding to elements in an attenuation coefficient image, the elements into different attenuation coefficient intervals, the different attenuation coefficient intervals having different image contrasts; an adjustment module configured to adjust, based on mapping functions respectively corresponding to the attenuation coefficient intervals, the attenuation coefficient value of the element in at least one attenuation coefficient interval, a slope of the mapping function of the attenuation coefficient interval with a minimum image contrast being greater than a slope of the mapping function of other attenuation coefficient interval; and a first determination module configured to obtain, based on adjusted attenuation coefficient values, a preprocessed image to be registered.

In a seventh aspect, the present disclosure provides a computer apparatus including a processor and a memory storing a computer program. The processor, when executing the computer program, implements the medical image registration method in the first aspect, the method for image registration based on a PET image in the third aspect, and the attenuation coefficient image processing method in the fifth aspect.

In an eighth aspect, the present disclosure provides a non-transitory computer-readable storage medium having a computer program stored therein. The computer program, when executed by a processor, causes the processor to implement the medical image registration method in the first aspect, the method for image registration based on a PET image in the third aspect, and the attenuation coefficient image processing method in the fifth aspect.

In a ninth aspect, the present disclosure provides a computer program product having a computer program stored therein. The computer program, when executed by a processor, causes the processor to implement the medical image registration method in the first aspect, the method for image registration based on a PET image in the third aspect, and the attenuation coefficient image processing method in the fifth aspect.

One or more embodiments of the present disclosure will be described in detail below with reference to drawings. Other features, objects and advantages of the present disclosure will become more apparent from the description, drawings, and claims.

### BRIEF DESCRIPTION OF THE DRAWINGS

In order to describe the technical solutions of the embodiments of the present disclosure more clearly, reference will now be made to the accompanying drawings, which are intended to be used in the description of the embodiments. The accompanying drawings, in the following description, illustrate merely some embodiments of the present disclosure, and do not constitute a limitation on the disclosure and scope of the present disclosure.

FIG. 1 is a flow diagram illustrating a medical image registration method in an embodiment.

FIG. 2 is a flow diagram illustrating a medical image registration method in another embodiment.

FIG. 3 is a flow diagram illustrating a method for obtaining a similarity weight distribution in an embodiment.

FIG. 4 is a flow diagram illustrating a method for obtaining a regularization weight distribution in an embodiment.

FIG. 5 is a block diagram illustrating a configuration of a medical image registration device in an embodiment.

FIG. 6 is a flow diagram illustrating a method for image registration based on a PET image in an embodiment.

FIG. 7 is a flow diagram illustrating a method for obtaining a similarity weight distribution in another embodiment.

FIG. 8 is a flow diagram illustrating a method for determining values of a first independent variable and a second independent variable in a negative correlation function in an embodiment.

FIG. 9 is a block diagram illustrating a configuration of a device for image registration based on a PET image in an embodiment.

FIG. 10 is a flow diagram illustrating an attenuation coefficient image processing method in an embodiment.

FIG. 11 is a schematic diagram illustrating attenuation coefficient values of the elements in an embodiment.

FIG. 12 is a schematic diagram illustrating an attenuation coefficient image before preprocessing in an embodiment.

FIG. 13 is a schematic diagram illustrating a preprocessed attenuation coefficient image in an embodiment.

FIG. 14 is a flow diagram illustrating a method for determining a linear piecewise function in an embodiment.

FIG. 15 is a flow diagram illustrating a method for determining a registered attenuation coefficient image in an embodiment.

FIG. 16 is a flow diagram illustrating a method for determining a target deformation field in an embodiment.

FIG. 17 is a flow diagram illustrating a method for determining a target deformation field in another embodiment.

FIG. 18 is a block diagram illustrating an attenuation coefficient image processing device in an embodiment.

FIG. 19 is a diagram illustrating an internal configuration of a computer apparatus in an embodiment.

### DETAILED DESCRIPTION OF THE EMBODIMENTS

In order to make the objectives, technical solutions and advantages of the present disclosure more clearly understood, the disclosure will be further described in detail with the accompanying drawings and embodiments. It should be understood that the specific embodiments described herein are only used to explain the disclosure and not to limit the disclosure.

Reference to “embodiments” in present disclosure means that particular features, structures, or characteristics described with reference to the embodiments can be included in at least one embodiment of the present disclosure. The occurrences of this phrase at various places in the specification do not necessarily refer to the same embodiment, nor are separate or alternative embodiments mutually exclusive of other embodiments. It is understood explicitly and implicitly by those skilled in the art that the embodiments described herein can be combined with other embodiments.

Medical image registration refers to performing one or a series of spatial transformations on a medical image, so that points of the medical image are spatially consistent with the corresponding points on another medical image or multiple medical images. In medical image registration, the medical image on which spatial transformation is performed is called a motion image, and the medical image that remains unchanged is called a reference image. The medical image registration process relates to at least two medical images, which can be of a same modality or different modalities.

In addition to the similarity term that represents the similarity between the reference image and the deformed motion image, the loss function further includes a regularization term that represents the smoothness of the deformation field. Both the similarity term and the regularization term are generally space-independent, i.e. all elements are treated equally in the registration. However, since different regions in a medical image have different degrees of tissue deformation and registration requirement accuracies, the conventional strategy is actually a relatively limited approach.

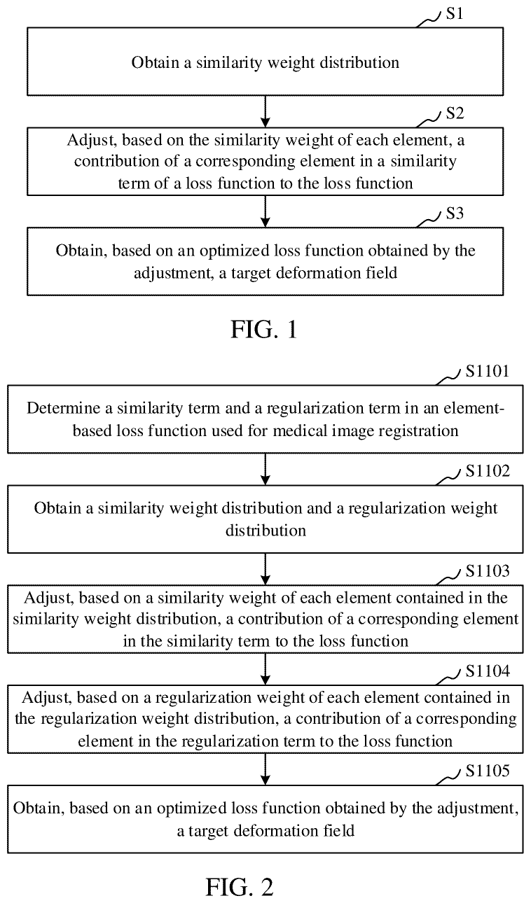

The embodiments of the present disclosure provide a medical image registration method. The method may be applied to registration scenarios of medical images of various modalities, including but not limited to registration between medical images of a same modality, and registration between medical images of different modalities. As shown in FIG. 1, the method includes the following steps.

In step S1, a similarity weight distribution is obtained.

The similarity weight distribution includes a similarity weight of each element. The element may be a voxel or a pixel. The similarity weight of the element having a positive correlation relationship with a registration requirement accuracy associated with a region in which the element is located, and a higher registration requirement accuracy associated with the region in which the element is located indicates a greater similarity weight of the element.

In step S2, a contribution of a corresponding element in a similarity term of a loss function to the loss function is adjusted based on the similarity weight of each element.

The loss function used for medical image registration includes the similarity term that constrains the similarity between the reference image and the motion image after a deformation field acts. The higher the registration requirement accuracy associated with the region in which the element is located, the greater the similarity weight of the element, and the greater the increase in the contribution of the element to the loss function in the similarity term, thus encouraging the image registration algorithm to pay more attention to the registration accuracy at a location of the element.

In step S3, a target deformation field is obtained based on an optimized loss function obtained by the adjustment.

The deformation field can be calculated by using the reference image and the motion image to minimize the optimized loss function, and the deformation field that minimizes the optimized loss function is taken as the target deformation field. The registration process in step S3 may be performed based on a conventional registration framework. The conventional registration framework is, for example, an image registration algorithm based on deep learning or non-deep learning.

In this medical image registration method, the contributions of the corresponding elements in the similarity term to the loss function are adjusted based on the registration requirement accuracies in different regions. Therefore, all elements can be treated differently in the registration process, and the registration requirements of different regions can be taken into account, thereby improving the registration accuracy and authenticity.

In an embodiment, the medical image registration method further includes: obtaining a regularization weight distribution containing a regularization weight of each element; and adjusting, based on the regularization weight of each element, a contribution of a corresponding element in a regularization term of the loss function to the loss function.

The loss function used for medical image registration includes the regularization term that constrains the smoothness of the deformation field. The regularization weight of the element has a negative correlation relationship with a degree of freedom of tissue deformation associated with a region in which the element is located. The greater the degree of freedom of tissue deformation associated with the region in which the element is located, the smaller the regularization weight of the element, and the smaller the contribution of the element to the loss function in the regularization term, so a region with a larger degree of freedom of tissue deformation can be simulated in the image registration process. The smaller the degree of freedom of tissue deformation associated with the region in which the element is located, the larger the regularization weight of the element, and the larger the contribution of the element to the loss function in the regularization term, so a region with a smaller degree of freedom of tissue deformation can be simulated in the image registration process.

In the above medical image registration method, the contributions of elements in the similarity term and the regularization term to the loss function are each adjusted, so all elements can be treated differently in the registration process, and degrees of tissue deformation and registration requirements in different regions can be taken into account, thereby improving the registration accuracy and authenticity.

A first aspect of the present disclosure provides a medical image registration method. The method may be applied to registration scenarios of medical images of various modalities, including but not limited to registration between medical images of a same modality, and registration between medical images of different modalities. The medical images of various modalities include but are not limited to positron emission computed tomography (PET) images, computed tomography (CT) images, and magnetic resonance (MR) images. The medical images may be three-dimensional images, or two-dimensional images, for example, a scout image (a positioning image) obtained by means of flat scanning is a two-dimensional image. The method may be performed by a computer apparatus, and includes the steps shown in FIG. 2.

In step S1101, a similarity term and a regularization term in an element-based loss function used for medical image registration are determined.

The image registration is mainly to determine a deformation field obtained by optimizing two images, so as to construct a pixel mapping relationship between the two images. Both the image registration algorithm based on deep learning and the image registration algorithm based on non-deep learning are involved in a loss function in the process of iterative optimization. Specifically, for an image registration algorithm based on non-deep learning, a deformation field is optimized between the reference image and the motion image to minimize the loss function, and the deformation field that minimizes the loss function can be taken as an optimized deformation field. For an image registration algorithm based on deep learning, a network parameter is optimized during network training. When image registration is subsequently performed, a deformation field is calculated based on an optimized network parameter.

The following describes the image registration algorithm as a B-spline registration algorithm as an example:
a) The input reference image and motion image are preprocessed.
b) A series of control points at equal intervals on the reference image are sampled, and positions of all the control points are used as parameters of a parametric model to represent a continuous deformation field of the entire image.
c) The loss function is defined as a difference between the reference image and a registered motion image.
d) According to a gradient descending method, all parameter values of the parametric model are iteratively adjusted according to a direction of descent of the loss function until the model converges.
e) By using the parametric model, a complete deformation field on the image is obtained by means of interpolation, to form an optimized deformation field.

The loss function used for medical image registration includes an element-based (i.e., intensity-based) loss function. The element may be a voxel or a pixel. This type of loss function may include two types of terms. One is a similarity term that constrains the similarity between the reference image and the motion image after the deformation field acts. The similarity term may be constructed based on a similarity index of intensity, including but not limited to a sum of squared difference (SSD), a correlation coefficient (CC), mutual information (MI), and the like. Another is a regularization term that constrains the smoothness of the deformation field. In addition, the medical image registration in this embodiment of the present disclosure may also be used for both rigid and non-rigid registration.

In step S1102, a similarity weight distribution and a regularization weight distribution are obtained.

The similarity weight distribution includes a similarity weight of each element. The similarity weight of the element has a positive correlation relationship with a registration requirement accuracy associated with a region in which the element is located, and a higher registration requirement accuracy associated with the region in which the element is located indicates a greater similarity weight of the element.

The regularization weight distribution includes a regularization weight of each element. The regularization weight of the element has a negative correlation relationship with a degree of freedom of tissue deformation associated with a region in which the element is located, and a greater degree of freedom of tissue deformation associated with the region in which the element is located indicates a smaller regularization weight of the element.

In step S1103, a contribution of a corresponding element in the similarity term to the loss function is adjusted based on a similarity weight of each element contained in the similarity weight distribution.

The higher the registration requirement accuracy associated with the region in which the element is located, the greater the similarity weight of the element, and the greater the increase in the contribution of the element to the loss function in the similarity term, thus encouraging the image registration algorithm to pay more attention to the registration accuracy at a location of the element. Similarly, the smaller the registration requirement accuracy associated with the region in which the element is located, the smaller the similarity weight of the element, and the smaller the contribution of the element to the loss function in the similarity term, thus encouraging the image registration algorithm to pay less attention to the registration accuracy at the location of the element.

In step S1104, a contribution of a corresponding element in the regularization term to the loss function is adjusted based on a regularization weight of each element contained in the regularization weight distribution.

Non-rigid registration of medical images is a very challenging technical issue. Different parts of the patient's body often have different movement trends and different degrees of tissue deformation. For example, under the influence of respiratory movement, a relatively large non-rigid deformation occurs in the liver and lung, and a volume of the lung changes, while a small amount of deformation occurs in the bladder. Based on this, in this embodiment of the present disclosure, the regularization term is adjusted based on the regularization weight of the element.

In the regularization term that constrains the smoothness of the deformation field, the greater the degree of freedom of tissue deformation associated with the region in which the element is located, the smaller the regularization weight of the element, and the smaller the contribution of the element to the loss function in the regularization term, so a region with a larger degree of freedom of tissue deformation can be simulated in the image registration process. The smaller the degree of freedom of tissue deformation associated with the region in which the element is located, the larger the regularization weight of the element, and the larger the contribution of the element to the loss function in the regularization term, so a region with a smaller degree of freedom of tissue deformation can be simulated in the image registration process.

In step S1105, a target deformation field is obtained based on an optimized loss function obtained by the adjustment.

After the adjustment in steps S1103 and S1104, the optimized loss function can be obtained, and a deformation field can be calculated by using the reference image and the motion image to minimize the optimized loss function. The deformation field that minimizes the optimized loss function is taken as the target deformation field. The registration process in step S1105 may be performed based on a conventional registration framework. The conventional registration framework is, for example, an image registration algorithm based on deep learning or non-deep learning. The registration algorithm based on non-deep learning is the B-spline registration algorithm described above.

In the above medical image registration method, the similarity term and the regularization term in the element-based loss function used for medical image registration are determined, and the similarity weight distribution and the regularization weight distribution are obtained. Further, based on the similarity weight of each element contained in the similarity weight distribution, the contribution of the corresponding element to the loss function in the similarity term is adjusted. The similarity weight of the element is positively correlated with the registration requirement accuracy associated with the region in which the element is located, and the higher registration requirement accuracy associated with the region in which the element is located indicates the greater similarity weight of the element. Based on the regularization weight of the element contained in the regularization weight distribution, the contribution of the corresponding element in the regularization term to the loss function is adjusted. The regularization weight of the element is negatively correlated with the degree of freedom of tissue deformation associated with the region in which the element is located, and the larger degree of freedom of tissue deformation of the region in which the element is located indicates the smaller regularization weight of the element. Therefore, all elements can be treated differently in the registration process, and degrees of tissue deformation and registration requirements in different regions can be taken into account, thereby improving the registration accuracy and authenticity.

In an embodiment, adjusting, based on the similarity weight of each element contained in the similarity weight distribution, the contribution of the corresponding element in the similarity term to the loss function in step S1103 may include: determining, for each element, based on a pixel value of the element in a reference image and a pixel value of the element in a motion image after a deformation field acts, a pixel difference term of the element in the similarity term; and assigning a corresponding similarity weight to the pixel difference term of each element.

Taking SSD as the similarity term as an example, the element-based loss function may be represented as follows:

$$L ( {I}_{ref} , {I}_{mov} ∘ ϕ ) = {L}_{sim} ( {I}_{ref} , {I}_{mov} ∘ ϕ ) + λ {L}_{reg} ,$$

$${L}_{sim} = {\sum }_{i ∈ I} {( {I}_{ref} ( i ) - {I}_{mov} ∘ ϕ ( i ) )}^{2} ,$$

where L, Lₛᵢₘ, and L_{reg} are a total loss function, a similarity term, and a regularization term, respectively, I_{ref}, Iₘₒᵥ, and ϕ are a reference image, a motion image, and a deformation field, respectively, Iₘₒᵥ∘ϕ denotes a motion image after the deformation field acts, λ is a constant that balances the similarity term and the regularization term, I is a set of all elements, and i denotes an element.

The above similarity term Lₛᵢₘ includes a pixel difference term of each element, and the pixel difference term of each element represents the following processing process: subtracting the pixel value of the element in the reference image I_{ref} and the pixel value of the element in the motion image Iₘₒᵥ∘ϕ after the deformation field acts to obtain a pixel error value of the element, and performing a square processing on the pixel error value of the element to obtain an error square value of the element. It is understandable that, when the similarity term is constructed based on a similarity indicator such as a correlation coefficient or mutual information, a processing process of representing the pixel difference term of each element may be different from the above.

After determining the pixel difference term of each element, the corresponding similarity weight is assigned to the pixel difference term of each element, so as to obtain an adjusted similarity term Lₛᵢₘ′=Σ_{i∈l}Wᵢ¹(I_{ref} (i)−Iₘₒᵥ∘ϕ(i))², where Wᵢ¹ represents the similarity weight of the element i.

It should be noted that, in the two medical images to be registered, the above-mentioned motion image is a medical image acted by the deformation field during the registration process, and the reference image is a medical image not acted by the deformation field during the registration process.

In an embodiment, adjusting, based on the regularization weight of each element contained in the regularization weight distribution, the contribution of the corresponding element in the regularization term to the loss function in step S1104, includes: determining, for each element, based on a gradient of a deformation field at the element in at least one spatial direction, a spatial gradient term of the element in the regularization term; and assigning a corresponding regularization weight to the spatial gradient term of each element.

Taking a sum of the gradients of the deformation field as the regularization term as an example, the regularization term may be represented as follows:

$${L}_{reg} = \frac{1}{\vert I \vert} {\sum }_{i ∈ I} {\sum }_{d ∈ D} {‖ ∇ ϕ ( d , i ) ‖}^{2} ,$$

where D is a set of three spatial directions of the deformation field (the three spatial directions may be perpendicular to each other, and may be represented by x, y, and z), and ∇ is a difference symbol.

The above regularization term L_{reg} includes a spatial gradient term of each element, and the spatial gradient term of each element represents the following processing process: calculating gradients of the deformation field at the element in a x direction, a y direction, and a z direction, respectively, and counting gradients of the deformation field at the element in all directions.

After determining the spatial gradient term of each element, the corresponding regularization weight may be assigned to the spatial gradient term of each element, so as to obtain an adjusted regularization term

$${{L}_{reg}}^{′} = \frac{1}{\vert I \vert} {\sum }_{i ∈ I} {\sum }_{d ∈ D} {W}_{i}^{2} {‖ ∇ ϕ ( d , i ) ‖}^{2} ,$$

where Wᵢ² represents the regularization weight of the element i.

The regularization term of the sum of the gradients of the deformation field described above belongs to a diffusion regularization term (a regularization term of a diffusion loss function), and the regularization term may further include but is not limited to: a total deviation regularization term (a regularization term of a total variation deviation loss function), or a bending energy regularization term (a regularization term of a bending energy loss function).

Based on the above adjusted similarity term Lₛᵢₘ′ and regularization term L_{reg}′, an optimized loss function may be obtained:

$${L ( {I}_{ref} , {I}_{mov} ∘ ϕ )}^{′} = {{L}_{sim} ( {I}_{ref} , {I}_{mov} ∘ ϕ )}^{′} + λ {{L}_{reg}}^{′} ,$$

According to the optimized loss function, the deformation field between the two medical images to be registered is optimized to obtain the target deformation field.

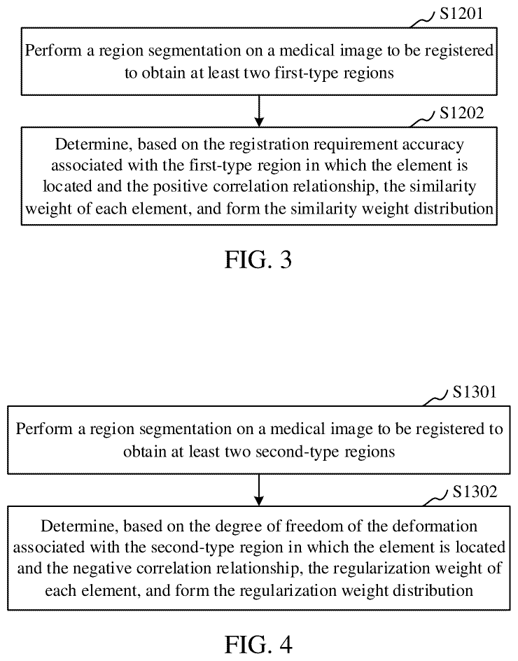

In an embodiment, as shown in FIG. 3, obtaining the similarity weight distribution in step S1102 includes: step S1201, performing a region segmentation on a medical image to be registered to obtain at least two first-type regions; each of the first-type regions being associated with respective registration requirement accuracy; step S1202, determining, based on the registration requirement accuracy associated with the first-type region in which the element is located and the positive correlation relationship, the similarity weight of each element, and forming the similarity weight distribution.

The computer apparatus may perform, based on registration requirement accuracies, the region segmentation on the medical image to be registered, and obtained regions may be referred to as first-type regions. Each of the first-type regions is associated with a corresponding registration requirement accuracy. For each element, the computer apparatus may determine a registration requirement accuracy associated with the first-type region in which the element is located, and determine a similarity weight of the element based on the positive correlation relationship between the similarity weight of the element and the registration requirement accuracy associated with the region in which the element is located, so as to obtain the similarity weights of the elements, and form the similarity weight distribution.

The computer apparatus may perform the above region segmentation by using a segmentation algorithm obtained in a manner such as deep learning.

The higher the interest of a user such as a doctor in a certain region, the higher the registration requirement accuracy of the region can be set. In some scenarios, a doctor has a relatively high interest in a lesion region and a relatively low interest in a non-lesion region. Based on this, the at least two first-type regions include a region of interest (ROI) and a non-ROI, and the registration requirement accuracy associated with the ROI is greater than the registration requirement accuracy associated with the non-ROI. The ROI may include a lesion region, a specific tissue or organ, and other region of clinical significance. The non-ROI may include a non-lesion region and any other region that is not of interest to a user. The registration requirement accuracy associated with the lesion region is greater than the registration requirement accuracy associated with the non-lesion region.

Further, when a user such as a doctor pay more attention to a large lesion region and less attention to a small lesion region, this indicates that the registration requirement accuracy of the large lesion region is higher than that of the small lesion region, resulting in the target deformation field easily mismatching the locally smaller lesion regions. Based on this, for lesion regions of different volumes, the user such as the doctor can further adjust the registration requirement accuracy according to the volume of the lesion region. It may be set that the smaller the volume of the lesion region, the larger the registration requirement accuracy, for example, the registration requirement accuracy of the small lesion region is set higher than that of the large lesion region, thereby improving the registration effect of small lesion regions.

In an embodiment, the computer apparatus can perform the above region segmentation by using an arbitrary segmentation algorithm to obtain a plurality of arbitrary ROIs, and assigning uniform or different similarity weights to the plurality of arbitrary ROIs.

In an embodiment, as shown in FIG. 4, obtaining the regularization weight distribution in step S1102 includes: step S1301, performing a region segmentation on a medical image to be registered to obtain at least two second-type regions; each of the second-type regions being associated with respective degree of freedom of tissue deformation; and step S1302, determining, based on the degree of freedom of the deformation associated with the second-type region in which the element is located and the negative correlation relationship, the regularization weight of each element, and forming the regularization weight distribution.

The computer apparatus may perform, based on degrees of freedom of tissue deformation, the region segmentation on the medical image to be registered, and obtained regions may be referred to as second-type regions. For example, a bone region and a soft tissue region may be obtained. Each of the second-type regions is associated with a corresponding degree of freedom of the tissue deformation. For each element, the computer apparatus may determine a degree of freedom of the tissue deformation associated with the second-type region in which the element is located, and determine a regularization weight of the element based on the negative correlation relationship between the regularization weight of the element and the degree of freedom of the tissue deformation associated with the region in which the element is located, so as to obtain the regularization weights of the elements, and form the regularization weight distribution.

In an embodiment, the statistical characteristics (such as an average motion amplitude and a degree of distortion) of different organs in the medical image with respect to the deformation field can be studied based on the deformation field obtained by the registration and an organ segmentation result, and then a empirical value of a degree of freedom of the tissue deformation of each organ can be determined, so as to assign corresponding regularization weights to different organs according to the empirical value of the degree of freedom of the tissue deformation of each organ. In some scenarios, different organs are assigned different regularization weights.

In the above embodiment, the medical image to be registered for performing the region segmentation may be a medical image used as the reference image, or may be a medical image used as the motion image.

The present disclosure further provides an embodiment. In this embodiment, performing the region segmentation on the medical image to be registered specifically includes the following steps: determining a reference image among the at least two medical images to be registered; and performing the region segmentation on the reference image.

In this embodiment, the region segmentation is performed on the reference image. Since the reference image in the similarity term is not acted by the deformation field, a loss value may be calculated directly based on the similarity weight distribution determined by the reference image, and it is not necessary to apply the deformation field to the similarity weight distribution before calculating the loss value, thereby simplifying the processing flow while ensuring the registration accuracy.

The computer apparatus may perform the above region segmentation by using a segmentation algorithm obtained in a manner such as deep learning.

In some scenarios, a weight of the similarity term of a certain part may be set to 0, so as to achieve registration of only part of the image. The weight of the regularization term corresponding to a part of tissue region (e.g., a bone region) may be set to a larger value, so as to impose rigid constraints on local deformation in the framework of non-rigid registration. The similarity weight of the tumor part may be increased to achieve a better tumor registration effect.

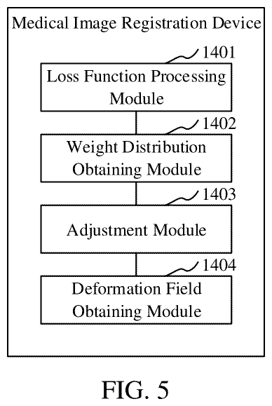

In an embodiment, as shown in FIG. 5, a second aspect of the present disclosure provides a medical image registration device. The medical image registration device includes a loss function processing module 1401, a weight distribution obtaining module 1402, an adjustment module 1403 and a deformation field obtaining module 1404.

The loss function processing module 1401 is configured to determine a similarity term and a regularization term in an element-based loss function used for medical image registration. The weight distribution obtaining module 1402 is configured to obtain a similarity weight distribution and a regularization weight distribution. The adjustment module 1403 configured to adjust, based on a similarity weight of each element contained in the similarity weight distribution, a contribution of a corresponding element in the similarity term to the loss function. The similarity weight of the element has a positive correlation relationship with a registration requirement accuracy associated with a region in which the element is located. The adjustment module 1403 is further configured to adjust, based on a regularization weight of each element contained in the regularization weight distribution, a contribution of a corresponding element in the regularization term to the loss function. The regularization weight of the element having a negative correlation relationship with a degree of freedom of tissue deformation associated with a region in which the element is located. The deformation field obtaining module 1404 is configured to obtain, based on an optimized loss function obtained by the adjustment, a target deformation field.

In an embodiment, the weight distribution obtaining module 1402 is further configured to perform a region segmentation on a medical image to be registered to obtain at least two first-type regions; each of the first-type regions being associated with a corresponding registration requirement accuracy; and determine, based on the registration requirement accuracy associated with the first-type region in which the element is located and the positive correlation relationship, the similarity weight of each element, and form the similarity weight distribution.

In an embodiment, the at least two first-type regions include a ROI and a non-ROI, and the registration requirement accuracy associated with the ROI is greater than the registration requirement accuracy associated with the non-ROI.

In an embodiment, the weight distribution obtaining module 1402 is further configured to perform a region segmentation on a medical image to be registered to obtain at least two second-type regions; each of the second-type regions being associated with a corresponding degree of freedom of the tissue deformation; and determine, based on the degree of freedom of the deformation associated with the second-type region in which the element is located and the negative correlation relationship, the regularization weight of each element, and form the regularization weight distribution.

In an embodiment, the weight distribution obtaining module 1402 is further configured to determine a reference image among the at least two medical images to be registered; and perform the region segmentation on the reference image.

In an embodiment, the adjustment module 1403 is further configured to determine, for each element, based on a pixel value of the element in a reference image and a pixel value of the element in a motion image after a deformation field acts, a pixel difference term of the element in the similarity term; and assign a corresponding similarity weight to the pixel difference term of each element.

In an embodiment, the adjustment module 1403 is further configured to determine, for each element, based on a gradient of a deformation field at the element in at least one spatial direction, a spatial gradient term of the element in the regularization term; and assign a corresponding regularization weight to the spatial gradient term of each element.

The specific features of the medical image registration device may be understood with reference to the features of the medical image registration method and will not be repeated here. The individual modules in the above medical image registration device can be implemented in whole or in part by software, hardware and combinations thereof. Each of the above modules may be embedded in hardware form or independent of a processor in a computer apparatus, or may be stored in software form on a memory in the computer apparatus so that the processor can be called to perform the operations corresponding to each of the above modules.

In the registration related to a PET image, the PET image may be registered with another PET image of a same modality, or the PET image may be registered with a medical image (such as a CT image) of another modality.

For this type of registration, to avoid the situation where the similarity term is space-independent, it is necessary to determine the similarity weight of each element in the similarity term adaptively.

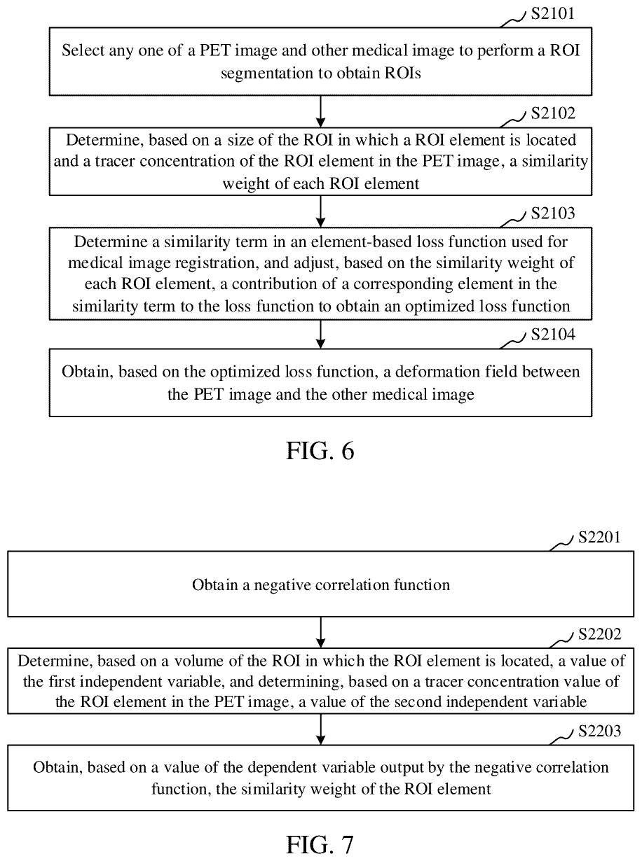

A third aspect of the present disclosure provides a registration method based on a PET image. The method may be performed by a computer apparatus, and includes the steps shown in FIG. 6. In addition, in the following description, an element in a ROI is referred to as a ROI element, and an element in a non-ROI is referred to as a non-ROI element. The element may be a voxel or a pixel.

In step S2101, any one of a PET image and other medical image is selected to perform a ROI segmentation to obtain ROIs.

The PET image is a medical image formed by using a positron emission computed tomography technology, and the other medical image is a medical image registered with the PET image. A modality of the other medical image may be the same as or different from that of the PET image, such as a CT image or an MR image. In some other embodiments, the other medical image may further be a corresponding attenuation coefficient image obtained after processing the PET image, the CT image, or the MR image, for example, an attenuation coefficient image obtained based on the CT image.

The ROI may include a lesion region, a specific tissue or organ, and other region of clinical significance. The non-ROI may include a non-lesion region and any other region that is not of interest to a user. For example, the computer apparatus may select any one of the PET image and the other medical image to perform a lesion region segmentation to obtain lesion regions.

In step S2102, a similarity weight of each ROI element is determined based on a size of the ROI in which a ROI element is located and a tracer concentration of the ROI element in the PET image.

The tracer concentration of the element in the PET image is a tracer concentration taken up by the tissue at the element. A tracer concentration value may be normalized by body weight and injection dose. In this case, the tracer concentration value may be referred to as a standardized uptake value (SUV).

When a volume of the lesion region is too small, it is difficult to register the lesion region, which affects the registration accuracy of the lesion region. When the tracer concentration of the lesion region is too low, it is also difficult to register the lesion region, which affects the registration accuracy of the lesion region.

Taking the ROI as the lesion region as an example, an element in the lesion region is referred to as a lesion region element, and an element in the non-lesion region is referred to as a non-lesion region element. In order to improve the registration accuracy of the lesion region, in this embodiment of the present disclosure, the similarity weight of the lesion region element is determined based on the size of the lesion region in which the lesion region element is located and the tracer concentration of the lesion region element in the PET image. The size of the lesion region in which the lesion region element is located has a negative correlation relationship with the similarity weight of the lesion region element, and the tracer concentration has a negative correlation relationship with the similarity weight of the lesion region element.

In step S2103, a similarity term in an element-based loss function used for medical image registration is determined, and a contribution of a corresponding element in the similarity term to the loss function is adjusted based on the similarity weight of each ROI element to obtain an optimized loss function.

For a specific process of step S2103, the description about adjusting the similarity term in the above step S1103 can be referred, which will not be described herein again.

In step S2104, a deformation field between the PET image and the other medical image is obtained based on the optimized loss function.

For a specific process of step S2104, the description in the above step S1105 can be referred, which will not be described herein again.

In this embodiment, any one of the PET image and the other medical image is selected to perform the lesion region segmentation to obtain lesion regions. Further, the similarity weight of the lesion region element is determined based on the size of the lesion region in which the lesion region element is located and the tracer concentration of the lesion region element in the PET image. The size of the lesion region in which the lesion region element is located has a negative correlation relationship with the similarity weight of the lesion region element, and the tracer concentration has a negative correlation relationship with the similarity weight of the lesion region element, thereby avoiding the influence of the registration effect of the lesion region due to the lesion region being too small or the tracer concentration of the lesion region being too low, and improving the registration accuracy of the lesion region.

In an embodiment, as shown in FIG. 7, determining, based on the size of the ROI in which the ROI element is located and the tracer concentration of the ROI element in the PET image, the similarity weight of each ROI element in step S2102 includes: step S2201, obtaining a negative correlation function; step S2202, determining, based on a volume of the ROI in which the ROI element is located, a value of a first independent variable, and determining, based on a tracer concentration value of the ROI element in the PET image, a value of a second independent variable; and step S2203, obtaining, based on a value of the dependent variable output by the negative correlation function, the similarity weight of the ROI element.

The negative correlation function includes a first independent variable, a second independent variable, and a dependent variable. Taking the ROI as the lesion region as an example, the value of the first independent variable and the value of the second independent variable are determined based on the volume of the lesion region in which the lesion region element is located and the tracer concentration value of the lesion region element in the PET image, and the value of the dependent variable is used to determine the similarity weight of the lesion region element. The first independent variable and the second independent variable may have a multiplication relationship, and the first independent variable and the second independent variable each have a negative correlation relationship with the dependent variable.

In this embodiment, after obtaining the negative correlation function, the value of the first independent variable may be determined based on the volume of the lesion region in which the lesion region element is located, and the value of the second independent variable may be determined based on the tracer concentration value of the lesion region element in the PET image. One of the determining manners may be, but is not limited to: taking the volume of the lesion region in which the lesion region element is located as the value of the first independent variable, and taking the tracer concentration value of the lesion region element in the PET image as the value of the second independent variable. Certainly, a person of ordinary skill in the art may determine the values of the above two independent variables in another manner after obtaining the volume of the lesion region in which the lesion region element is located and the tracer concentration value of the lesion region element in the PET image, which is not limited thereto in this embodiment of the present disclosure.

After determining the value of the first independent variable and the value of the second independent variable, the value of the dependent variable output by the negative correlation function may be obtained by inputting the two values into the negative correlation function, so as to obtain the similarity weight of each lesion region element, and form the similarity weight distribution. One of the processing manners may be, but is not limited to: directly taking the value of the dependent variable as the similarity weight of the lesion region element. Certainly, some processing may also be performed on the value of the dependent variable, and a processing result is taken as the similarity weight of the lesion region element.

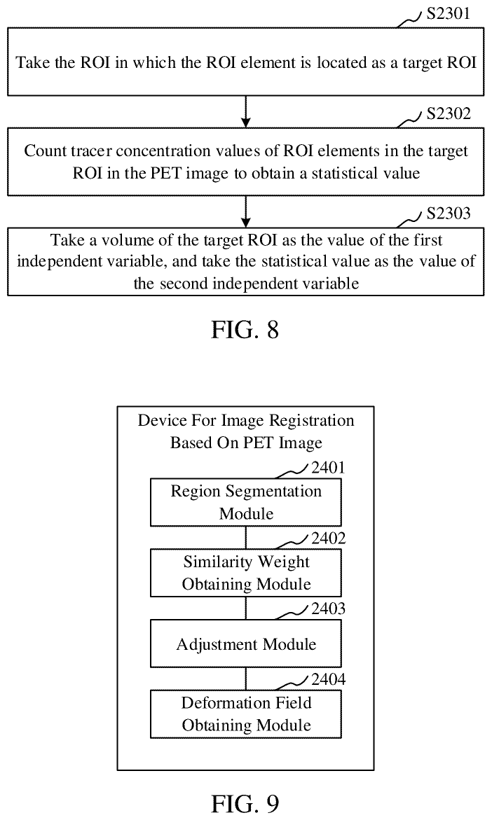

In an embodiment, as shown in FIG. 8, determining, based on the volume of the ROI in which the ROI element is located, the value of the first independent variable, and determining, based on the tracer concentration value of the ROI element in the PET image, the value of the second independent variable, includes: step S2301, taking the ROI in which the ROI element is located as a target ROI; step S2302, counting tracer concentration values of the ROI elements in the target ROI in the PET image to obtain a statistical value; and step S2303, taking a volume of the target ROI as the value of the first independent variable, and taking the statistical value as the value of the second independent variable.

In this embodiment, taking the ROI as the lesion region as an example, the tracer concentration values of lesion region elements in the target lesion region are counted to obtain the statistical value, and then the volume of the target lesion region is taken as the value of the first independent variable, and the statistical value is taken as the value of the second independent variable, so that the similarity weights obtained may be taken as similarity weights of the lesion region elements in the target lesion region.

The statistical manner may be determined according to an actual demand. For example, the tracer concentration values of the lesion region elements in the target lesion region are summed, and the obtained statistical value is the sum value. The sum value is multiplied by the volume of the target lesion region to obtain a product result. When the tracer is a radioactive tracer used to evaluate the glycolysis activity of the tumor, the product result commonly referred to as a total lesion glycolysis (TLG). In this case, the negative correlation function may be represented as follows:

$${W}_{i} = \frac{1}{{TLG}_{i}} ,$$

where i denotes a lesion region element, TLGᵢ denotes a TLG of a lesion region in which the lesion region element i is located, and Wᵢ denotes a similarity weight of the lesion region element i. In addition, hyper-parameters may also be set at the numerator and denominator of the negative correlation function, so as to control the magnitude of the similarity weight. For example, a negative correlation function may be obtained, which is represented as follows:

$${W}_{i} = \frac{α}{{TLG}_{i} + ε} ,$$

where α and ε are artificial hyper-parameters.

In another embodiment, the statistical manner may be performed in an averaging manner. In this case, counting the tracer concentration values of the lesion region elements in the target lesion region in the PET image to obtain the statistical value, specifically includes the following steps: performing an average processing on the tracer concentration values of the lesion region elements in the target lesion region in the PET image to obtain an average value.

After obtaining the statistical value, i.e., the average value, the average value is multiplied by the volume of the target lesion region to obtain a product result. When the tracer is a radioactive tracer used to evaluate the glycolysis activity of the tumor, the product result commonly referred to as a total lesion glycolysis (TLG). In this case, the negative correlation function may be represented as follows:

$${W}_{i} = \frac{1}{{TLG}_{i}} ,$$

where i denotes a lesion region element, TLGᵢ denotes a TLG of a lesion region in which the lesion region element i is located, and Wᵢ denotes a similarity weight of the lesion region element i. In addition, hyper-parameters may also be set at the numerator and denominator of the negative correlation function, so as to control the magnitude of the similarity weight. For example, a negative correlation function may be obtained, which is represented as follows:

$${W}_{i} = \frac{α}{{TLG}_{i} + ε} ,$$

where α and ε are hyper-parameters set by a person.

In an embodiment, the method provided in the present disclosure further includes: obtaining a set value that is smaller than the similarity weight of each ROI element; taking the set value as a similarity weight of a non-ROI element; and adjusting, based on the similarity weight of the non-ROI element, a contribution of a corresponding element in the similarity term to the loss function.

Taking the ROI as the lesion region as an example, when a user such as a doctor pays more attention to the registration accuracy of the lesion region and pays less attention to the registration accuracy of the non-lesion region, the similarity weight of the non-lesion region element may be less than the similarity weight of the lesion region element.

In this embodiment, the set value that is less than the similarity weight of each lesion region element is determined, and the set value is taken as the similarity weight of the non-lesion region element. After obtaining the similarity weight of the non-lesion region element, the contribution of the corresponding element in the similarity term to the loss function may be adjusted. For a specific process, the description about adjusting the similarity term can be referred, which will not be described herein again.

In some scenarios, when the similarity weights of the lesion region elements are each greater than 1, 1 may be taken as the set value.

In an embodiment, selecting any one of the PET image and the other medical image to perform the ROI segmentation to obtain the ROIs in step S2101 includes: selecting the PET image from the PET image and the other medical image to perform the ROI segmentation to obtain the ROIs.

Taking the ROI as the lesion region as an example, considering that when determining the similarity weight of the lesion region element in step S2102, the tracer concentration value of the lesion region element in the PET image needs to be used, in order to ensure the accuracy of the similarity weight and simplify the processing flow, the PET image is selected to perform the lesion region segmentation to obtain the lesion regions in this embodiment.

In an embodiment, selecting the PET image to perform the ROI segmentation to obtain the ROIs may include: obtaining a segmentation algorithm pre-built based on deep learning; and inputting the PET image into the segmentation algorithm to obtain the ROIs.

In an embodiment, inputting the PET image into the segmentation algorithm to obtain the ROIs may include: obtaining, by inputting the PET image into the segmentation algorithm, a ROI distribution map output by the segmentation algorithm; and processing, by using a connected region algorithm, the ROI distribution map to obtain the ROIs which are independent with each other.

In an embodiment, selecting the PET image to perform the ROI segmentation to obtain the ROIs may include: obtaining a ROI distribution map obtained by manually annotating the PET image by a user, and processing, by using a connected region algorithm, the ROI distribution map to obtain the ROIs which are independent with each other.

In an embodiment, selecting the PET image to perform the ROI segmentation to obtain the ROIs may include: processing, by using a segmentation algorithm built by non-deep learning, on the medical image to be registered to obtain a ROI distribution map, and processing, by using a connected region algorithm, the ROI distribution map to obtain the ROIs which are independent with each other.

The segmentation algorithm built by non-deep learning is, for example, a segmentation algorithm related to a threshold, or an image feature extraction and post-processing algorithm.

In an embodiment, as shown in FIG. 9, a fourth aspect of the present disclosure provides a device for image registration based on a PET image. The device includes a region segmentation module 2401, a similarity weight obtaining module 2402, an adjustment module 2403, and a deformation field obtaining module 2404.

The region segmentation module 2401 is configured to select any one of a PET image and other medical image to perform a ROI segmentation to obtain ROIs. The other medical image is of the same or different modality as the PET image. The similarity weight obtaining module 2402 is configured to determine, based on a size of the ROI in which a ROI element is located and a tracer concentration of the ROI element in the PET image, a similarity weight of each ROI element. The adjustment module 2403 is configured to determine a similarity term in an element-based loss function used for medical image registration, and adjust, based on the similarity weight of each ROI element, a contribution of a corresponding element in the similarity term to the loss function to obtain an optimized loss function. The deformation field obtaining module 2404 is configured to obtain, based on the optimized loss function, a deformation field between the PET image and the other medical image.

In an embodiment, the similarity weight obtaining module 2402 is further configured to: obtain a negative correlation function; determine, based on a volume of the ROI in which the ROI element is located, a value of the first independent variable, and determine, based on a tracer concentration value of the ROI element in the PET image, a value of the second independent variable; and obtain, based on a value of the dependent variable output by the negative correlation function, the similarity weight of the ROI element. In the negative correlation function, a first independent variable and a second independent variable have a multiplication relationship, and each of the first independent variable and the second independent variable has a negative correlation relationship with a dependent variable.

In an embodiment, the similarity weight obtaining module 2402 is further configured to take the ROI in which the ROI element is located as a target ROI; count tracer concentration values of the ROI elements in the target ROI in the PET image to obtain a statistical value; and take a volume of the target ROI as the value of the first independent variable, and take the statistical value as the value of the second independent variable.

In an embodiment, the similarity weight obtaining module 2402 is further configured to perform an average processing on the tracer concentration values of the ROI elements in the target ROI in the PET image to obtain an average value.

In an embodiment, the similarity weight obtaining module 2402 is further configured to obtain a set value that is smaller than the similarity weight of each ROI element; take the set value as a similarity weight of a non-ROI element; and adjust, based on the similarity weight of the non-ROI element, a contribution of a corresponding element in the similarity term to the loss function.

In an embodiment, the region segmentation module 2401 is further configured to select the PET image from the PET image and the other medical image to perform the ROI segmentation to obtain the ROIs.

In an embodiment, the region segmentation module 2401 is further configured to obtain a segmentation algorithm pre-built based on deep learning; and input the PET image into the segmentation algorithm to obtain the ROIs.

In an embodiment, the region segmentation module 2401 is further configured to obtain, by inputting the PET image into the segmentation algorithm, a ROI distribution map output by the segmentation algorithm; and process, by using a connected region algorithm, the ROI distribution map to obtain the ROIs which are independent with each other.

The specific features of the image registration apparatus based on a PET image may be understood with reference to the features of the method for image registration based on a PET image and will not be repeated here. The individual modules in the above image registration apparatus based on a PET image can be implemented in whole or in part by software, hardware and combinations thereof. Each of the above modules may be embedded in hardware form or independent of a processor in a computer apparatus, or may be stored in software form on a memory in the computer apparatus so that the processor can be called to perform the operations corresponding to each of the above modules.

As described above, in the image registration process, the two medical images to be registered may be medical images of a same modality, or may be medical images of different modalities, such as registration between a PET image and a CT image. In addition, in some embodiments, at least one of the two medical images to be registered is an attenuation coefficient image. In this case, the image registration process may be registration between a medical image of a certain modality and an attenuation coefficient image. For example, registration between a PET image and an attenuation coefficient image, where the attenuation coefficient image may be a corresponding attenuation coefficient image obtained after processing a PET image, a CT image, or an MR image.

When the at least one of the two medical images to be registered is an attenuation coefficient image, the medical image to be registered may be pre-preprocessed before registration. For example, the attenuation coefficient image may be an attenuation coefficient image corresponding to a CT image by means of bilinear transformation, may be an attenuation coefficient image generated by means of end-to-end learning by using a PET image, or may be an attenuation coefficient image generated by using a deep learning network by using an MR image.

In addition, attenuation coefficient images are of great significance to PET reconstruction, and their accuracy directly affects the quality of PET reconstructed images. An inaccurate attenuation coefficient image may result in attenuation correction artifacts when reconstructing the image. In order to solve the problem of attenuation correction artifacts, registration of attenuation coefficient images is particularly important. However, the registration accuracy of the attenuation coefficient image is generally related to a contrast of the attenuation coefficient image. The best registration accuracy can be achieved when the boundaries of organs or tissues are clear and the attenuation coefficient values differ greatly. Therefore, the registration of regions with large differences in attenuation coefficient values in the attenuation coefficient image can achieve a better effect by using a registration algorithm, while for the junctions of a kidney, a fat, a liver and other parts with close attenuation coefficient values, the registration accuracy is poor.

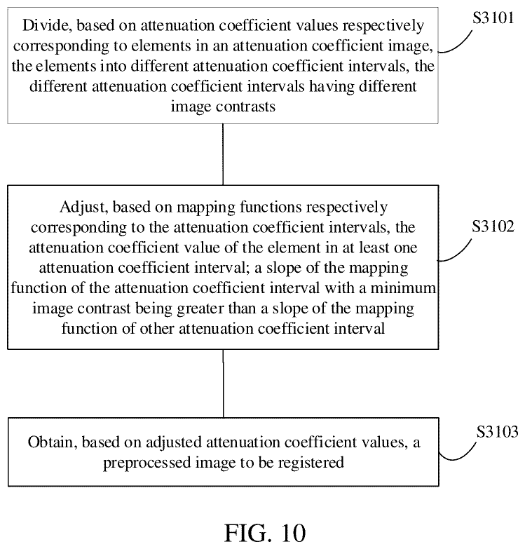

In an embodiment, as shown in FIG. 10, a fifth aspect of the present disclosure provides an attenuation coefficient image processing method. An example where the method is applied to a computer apparatus for description, the method includes the following steps:

In step S3101, based on attenuation coefficient values respectively corresponding to elements in an attenuation coefficient image, the elements are divided into different attenuation coefficient intervals. The different attenuation coefficient intervals have different image contrasts. The element may be a voxel or a pixel.

In this embodiment, after obtaining the attenuation coefficient values corresponding to the elements and preset attenuation coefficient intervals, the attenuation coefficient values corresponding to the elements may be divided into the different attenuation coefficient intervals. Optionally, the preset attenuation coefficient intervals may be three attenuation coefficient intervals, namely, a low-density attenuation coefficient interval, a medium-density attenuation coefficient interval, and a high-density attenuation coefficient interval. The preset attenuation coefficient intervals may be four or more attenuation coefficient intervals.

In a case that the preset attenuation coefficient intervals include the low-density attenuation coefficient interval, the medium-density attenuation coefficient interval, and the high-density attenuation coefficient interval, the elements are divided into the different attenuation coefficient intervals based on the attenuation coefficient values corresponding to the elements. For example, the low-density attenuation coefficient interval mainly includes elements of tissues such as a lung and a cavity, the medium-density attenuation coefficient interval mainly includes elements of tissues such as a muscle, a fat, a kidney, and a liver, and the high-density attenuation coefficient interval mainly includes elements of tissues such as a bone.

In step S3102, based on mapping functions respectively corresponding to the attenuation coefficient intervals, the attenuation coefficient value of the element in at least one attenuation coefficient interval is adjusted. A slope of the mapping function of the attenuation coefficient interval with a minimum image contrast is greater than a slope of the mapping function of other attenuation coefficient interval.

In this embodiment, each of the attenuation coefficient intervals corresponds to a monotone mapping function. Optionally, the mapping function may be a piecewise linear function. In this embodiment, an example where the mapping function is taken as the piecewise linear function for description. Based on piecewise linear functions respectively corresponding to the attenuation coefficient intervals, the attenuation coefficient value of the element in at least one attenuation coefficient interval is adjusted according to an actual demand. A slope of the piecewise linear function of the attenuation coefficient interval with the minimum image contrast is greater than a slope of the piecewise linear function of other attenuation coefficient interval. Specifically, the attenuation coefficient value of the element in the attenuation coefficient interval that needs to be adjusted is substituted into the piecewise linear function corresponding to a corresponding attenuation coefficient interval, so as to obtain the adjusted attenuation coefficient value of each element.

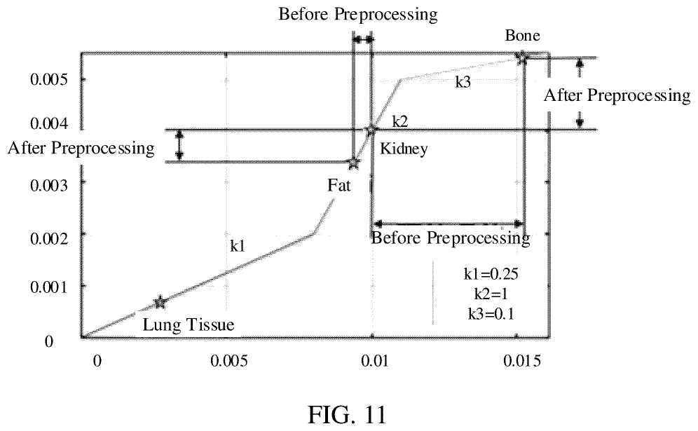

As shown in FIG. 11, FIG. 11 is a schematic diagram illustrating attenuation coefficient values of the elements with a photon energy of 511 keV in an embodiment. The horizontal axis represents an attenuation coefficient value, and the vertical axis represents an adjusted attenuation coefficient value. There are piecewise linear functions for three attenuation coefficient intervals shown in FIG. 11. The piecewise linear functions corresponding to the three attenuation coefficient intervals are as follows: a piecewise linear function for the low-density attenuation coefficient interval is denoted as y1=k1*x (0≤x<x1); a piecewise linear function for the medium-density attenuation coefficient interval is denoted as y2=k2*x+k1*x1−k2*x1 (x1≤x<x2); and a piecewise linear function for the high-density attenuation coefficient interval is denoted as y3=k3*x+k2*x2+k1*x1−k2*x1−k3*x2 (x2≤x≤x3), where k1, k2, and k3 are each greater than 0, x is an attenuation coefficient value of each element, and y is an adjusted attenuation coefficient value of each element.

It should be noted that the piecewise linear function is a continuous and monotonically increasing function. For example, the piecewise linear function y1 for the low-density attenuation coefficient interval, the piecewise linear function y2 for the medium-density attenuation coefficient interval, and the piecewise linear function y3 for the high-density attenuation coefficient interval are each continuous and monotonically increasing.

In an embodiment, the image contrasts in the high, medium and low density attenuation coefficient intervals are respectively: the image contrast of the medium-density attenuation coefficient interval is the smallest, followed by the image contrast of the low-density attenuation coefficient interval, and the image contrast of the high-density attenuation coefficient interval is the largest. Therefore, k2 can be set greater than k1, and k1 can be set greater than k3. If the image contrast of the low-density attenuation coefficient interval is not significantly different from that of the high-density attenuation coefficient interval, it is only necessary to meet that k2 is a maximum value, and a relationship between k1 and k3 is not specifically limited. Alternatively, in other embodiments, only the attenuation coefficient values of a part of the attenuation coefficient intervals may be adjusted, such as only adjusting the attenuation coefficient value of element in one attenuation coefficient interval (such as the medium-density attenuation coefficient interval).

FIG. 11 shows attenuation coefficient values of elements of several major tissues. It can be seen that the attenuation coefficient value of the element in the kidney is significantly close to that of the element in the fat, in other words, a projection of the element in the kidney in an x-axis direction is significantly close to that of the element in the fat in the x-axis direction. After being processed by the piecewise linear function, a difference between a projection of the element in the kidney in a y-axis direction and a projection of the element in the fat in the y-axis direction becomes larger.

It should be noted that, a main purpose of using the piecewise linear function is to increase a difference in attenuation coefficient values of elements that are closer. Therefore, in a process of mapping the attenuation coefficient values of the elements by using the piecewise linear function, the elements that originally had a large difference in the attenuation coefficient values may have a smaller difference in the new attenuation coefficient values after the mapping process, but as long as the difference in the new attenuation coefficient values is greater than a preset difference. For example, the element of kidney tissue and the element of bone tissue.

In step S3103, a preprocessed image to be registered is obtained based on adjusted attenuation coefficient values.

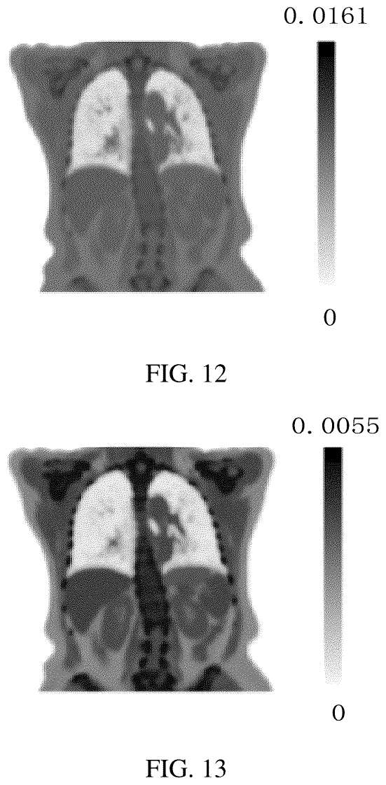

For the attenuation coefficient value of the element that needs to be adjusted, the above operation is repeated, and the attenuation coefficient value of the corresponding element in the attenuation coefficient image is replaced with a mapped new attenuation coefficient value, so as to obtain the preprocessed attenuation coefficient image as the subsequent image to be registered. As shown in FIG. 12 and FIG. 13, FIG. 12 is a schematic diagram illustrating an attenuation coefficient image before preprocessing in an embodiment, and FIG. 13 is a schematic diagram illustrating a preprocessed attenuation coefficient image in an embodiment. By comparing FIG. 12 and FIG. 13, it can be clearly seen that edges of the liver and the kidney become clearer, and the contrast between different tissues becomes larger.

In the above attenuation coefficient image processing method, the elements are divided into different attenuation coefficient intervals based on the attenuation coefficient values respectively corresponding to the elements in the attenuation coefficient image, and the attenuation coefficient value of the element in at least one attenuation coefficient interval is adjusted based on the mapping functions respectively corresponding to the attenuation coefficient intervals. Then the preprocessed attenuation coefficient image is obtained based on the adjusted attenuation coefficient values. The different attenuation coefficient intervals have different image contrasts. In this embodiment of the present disclosure, the slope of the mapping function of the attenuation coefficient interval with a minimum image contrast is greater than the slope of the mapping function of the other attenuation coefficient interval. Therefore, the attenuation coefficient values of the elements in the attenuation coefficient image are mapped based on the mapping functions respectively corresponding to the attenuation coefficient intervals to adjust the attenuation coefficient values in the attenuation coefficient image, thereby achieving a contrast enhancement effect and optimizing the registration performance of the attenuation coefficient image.

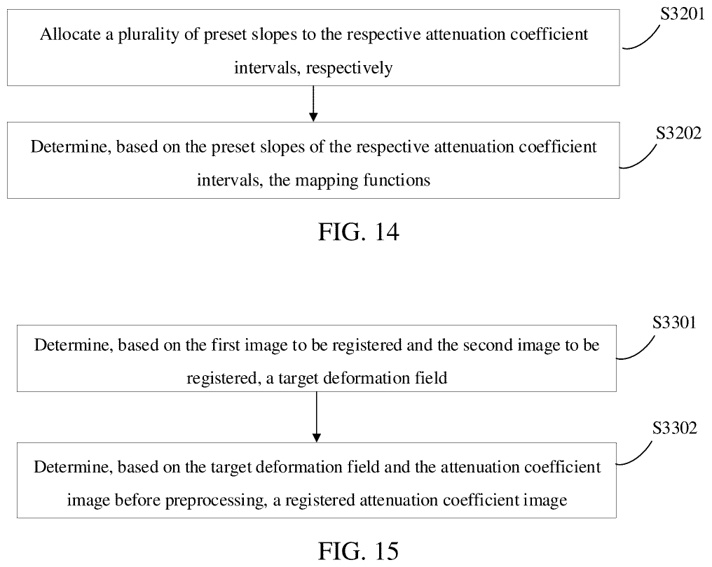

FIG. 14 is a flow diagram illustrating a method for determining a linear piecewise function in an embodiment. As shown in FIG. 14, the method includes the following steps.

In step S3201, a plurality of preset slopes are allocated to the respective attenuation coefficient intervals, respectively.

Optionally, the preset slope may be 0.2, 0.5, or the like, and the preset slope may be determined based on a large number of attenuation coefficient images.

In this embodiment, a maximum preset slope may be allocated to an attenuation coefficient interval with a minimum image contrast, and other preset slopes are randomly allocated to other attenuation coefficient intervals.

In a possible implementation, the preset slopes may be sorted in an ascending order to obtain a first sorting result, and the contrasts respectively corresponding to the attenuation coefficient intervals may be sorted in a descending order to obtain a second sorting result. Further, the first sorting result is one-to-one matched with the second sorting result. In this case, the maximum preset slope is allocated to the attenuation coefficient interval corresponding to the minimum contrast in the sorting result, and the minimum preset slope is allocated to the attenuation coefficient interval corresponding to the maximum contrast in the sorting result.

In step S3202, the mapping functions are determined based on the preset slopes of the respective attenuation coefficient intervals.

In this embodiment, an example where the mapping function is taken as a piecewise linear function for description. The piecewise linear functions are determined based on the preset slopes of the respective attenuation coefficient intervals. Exemplarily, there are three attenuation coefficient intervals, the three attenuation coefficient intervals are respectively denoted as: [0, x1], [x1, x2], and [x2, x3], and the preset slopes are k1, k2, and k3, respectively.

The piecewise linear functions respectively corresponding to the attenuation coefficient intervals are represented as follows:

$$\begin{matrix}y 1 = k 1 * x & ( 0 \leq x < x 1 )\end{matrix} ,$$

$$\begin{matrix}y 2 = k 2 * x + k 1 * x 1 - k 2 * x 1 & ( x 1 \leq x < x 2 )\end{matrix} , and$$

$$\begin{matrix}y 3 = k 3 * x + k 2 * x 2 + k 1 * x 1 - k 2 * x 1 - k 3 * x 2 & ( x 2 \leq x \leq x 3 )\end{matrix} .$$

In a case that there are two attenuation coefficient intervals, the piecewise linear functions respectively corresponding to the attenuation coefficient intervals are represented as follows:

$$\begin{matrix}y 1 = k 1 * x & ( 0 \leq x < x 1 )\end{matrix} , and$$

$$\begin{matrix}y 2 = k 2 * x + k 1 * x 1 - k 2 * x 1 & ( x 1 \leq x \leq x 2 )\end{matrix} .$$

In this embodiment of the present disclosure, the plurality of preset slopes are allocated to the attenuation coefficient intervals, respectively, and the corresponding piecewise linear functions are determined based on the preset slopes of the attenuation coefficient intervals. In this embodiment, the plurality of preset slopes are allocated to the attenuation coefficient intervals based on the image contrasts of different attenuation coefficient intervals, and the piecewise linear function is determined based on the preset slope, thereby improving the efficiency of determining the piecewise linear function.

FIG. 15 is a flow diagram illustrating a method for determining a registered attenuation coefficient image in an embodiment. As shown in FIG. 15, the method includes the following steps.

In step S3301, a target deformation field is determined based on a first image to be registered and a second image to be registered.

Optionally, the attenuation coefficient image may be taken as a motion image or a reference image. In an embodiment, one of the two images to be registered is the first image to be registered as the motion image, and the other is the second image to be registered as the reference image.

In this embodiment, in a case that the first image to be registered and/or the second image to be registered are attenuation coefficient images, the above preprocessing may be performed on the first image to be registered and/or the second image to be registered, so as to obtain a preprocessed first image to be registered and/or a preprocessed second image to be registered.

In an embodiment, in a case that only the first image to be registered is an attenuation coefficient image, the above preprocessing is performed on the first image to be registered to obtain the preprocessed first image to be registered. Further, the preprocessed first image to be registered and the second image to be registered that does not perform the above preprocessing are registered to obtain the target deformation field. For example, the preprocessed first image to be registered and the second image to be registered that does not perform the above preprocessing are registered by using a non-rigid image registration algorithm based on a B-spline, to obtain the target deformation field.

In step S3302, a registered attenuation coefficient image is determined based on the target deformation field and the attenuation coefficient image before preprocessing.

In this embodiment, the target deformation field is applied to the attenuation coefficient image before preprocessing to obtain a deformed attenuation coefficient image, i.e., the registered attenuation coefficient image.

In this embodiment of the present disclosure, the target deformation field is determined based on the first image to be registered and the second image to be registered, and then the registered attenuation coefficient image is determined based on the target distortion field and the preprocessed attenuation coefficient image. Since the target deformation field is determined based on the first image to be registered and the second image to be registered in this embodiment, and at least one of the first image to be registered and the second image to be registered performs a contrast enhancement processing, the determination of the target deformation field is more accurate, thereby improving the registration accuracy of the attenuation coefficient image.

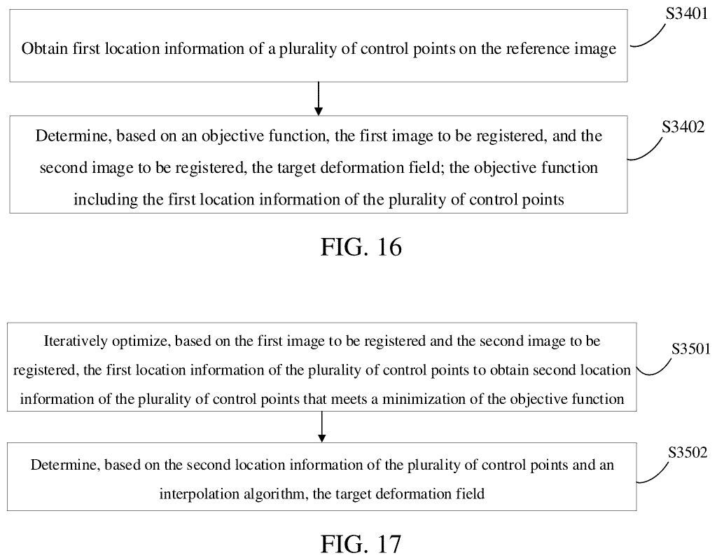

FIG. 16 is a flow diagram illustrating a method for determining a target deformation field in an embodiment. As shown in FIG. 16, this embodiment of the present disclosure relates to a possible implementation manner of determining the target deformation field based on the first image to be registered and the second image to be registered, including the following steps:

In step S3401, first location information of a plurality of control points on the reference image is obtained.

In this embodiment, the first location information of the plurality of control points may be obtained at equal intervals on the reference image, or the first location information of the plurality of control points may be randomly obtained on the reference image. For each control point, its original location in the reference image is taken as the first location information. As an example, the first location information may be coordinate information of the plurality of control points in a Cartesian coordinate system.

In step S3402, the target deformation field is determined based on an objective function, the first image to be registered, and the second image to be registered. The objective function includes the first location information of the plurality of control points.

In this embodiment, the first location information of the control points in the objective function may be optimized based on the first image to be registered and the second image to be registered, so as to obtain second location information of the control points when the objective function converges, and then an interpolation processing is performed on the second location information of the control points by using an interpolation algorithm to obtain the target deformation field. As an example, the second location information may be coordinate information obtained by optimizing the first location information of the plurality of control points.

In a possible implementation, after obtaining the second location information of the control points, the second location information of the control points is processed by using a matrix decomposition method or a matrix approximation method to obtain the target deformation field.

In this embodiment of the present disclosure, the first location information of the plurality of control points on the reference image is obtained, and then the target deformation field is determined based on the objective function, the first image to be registered, and the second image to be registered. In this embodiment, since a contrast enhancement processing is performed on the at least one of the first image to be registered and the second image to be registered, the accuracy of determining the target deformation field based on the first image to be registered and the second image to be registered is improved.

FIG. 17 is a flow diagram illustrating a method for determining a target deformation field in another embodiment. As shown in FIG. 17, this embodiment of present disclosure relates to a possible implementation manner of determining the target deformation field based on the objective function, the first image to be registered, and the second image to be registered, including the following steps:

In step S3501, the first location information of the plurality of control points is iteratively optimized based on the first image to be registered and the second image to be registered, to obtain second location information of the plurality of control points that meets a minimization of the objective function.

In this embodiment, iterative optimization is performed on the first location information of the plurality of control points based on the first image to be registered and the second image to be registered, until the objective function converges to obtain the second location information of the plurality of control points. For example, parameter information of the first image to be registered and the second image to be registered is substituted into the objective function, and then according to a descending direction of the objective function, the first location information of the control points is iteratively optimized by using a gradient descent method, a least squares method, a genetic algorithm, and the like to minimize the objective function.

In step S3502, the target deformation field is determined based on the second location information of the plurality of control points and an interpolation algorithm.

In this embodiment, since the first location information of the control points is location information of the plurality of control points obtained in the reference image, and the second location information of the control points is obtained by iteratively optimizing the first location information of the control points, the second location information of the control points may be restored to the target deformation field with the same dimensions as the reference image by using the interpolation algorithm. Optionally, a B-spline interpolation algorithm, a nearest neighbor interpolation algorithm, a bilinear interpolation algorithm, and the like may be used. Taking the B-spline interpolation algorithm as an example, for each element of the deformation field, the control points that affect the element and the weights corresponding to these control points can be determined through a B-spline basis function. Then, the deformation of the element can be obtained by weighting the displacement of these control points (the displacement of the second location relative to the first location), thereby obtaining a complete target deformation field.

In this embodiment of the present disclosure, the first location information of the plurality of control points is iteratively optimized based on the first image to be registered and the second image to be registered, to obtain the second location information of the plurality of control points that meet the minimization of the objective function, and then the target deformation field is determined based on the second location information of the plurality of control points and the interpolation algorithm. In this embodiment, the first location information of the plurality of control points is iteratively optimized to minimize the objective function, so as to obtain the second location information of the control points, thereby improving the accuracy of determining the target deformation field based on the second location information of the control points, and providing a basis for subsequently determining the registered attenuation coefficient image based on the target deformation field and the attenuation coefficient image before preprocessing.

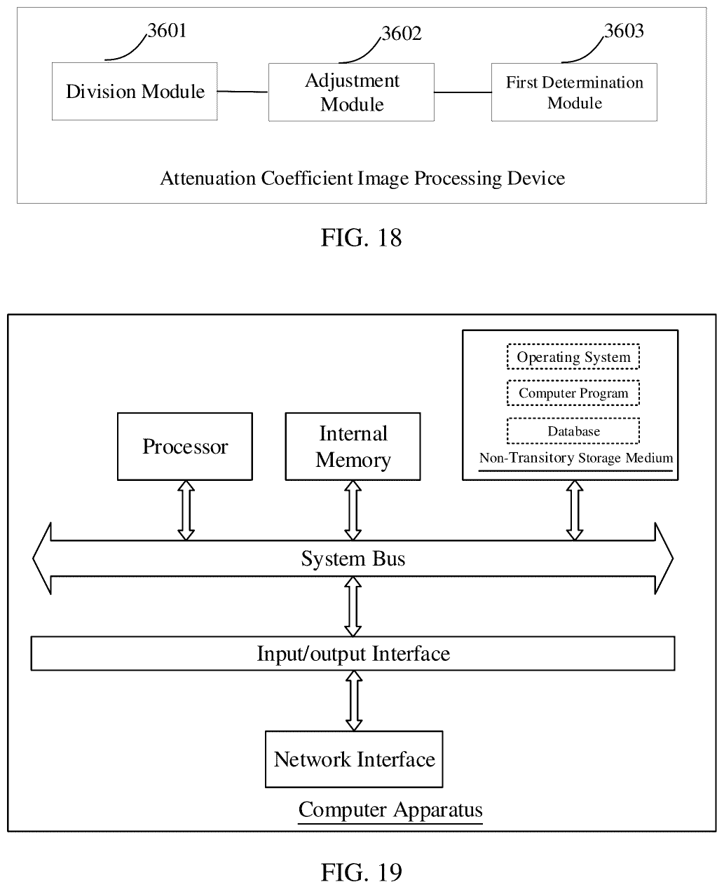

In an embodiment, as shown in FIG. 18, a sixth aspect of the present disclosure provides an attenuation coefficient image processing device. The attenuation coefficient image processing device includes a division module 3601, an adjustment module 3602, and a first determination module 3603.

The division module 3601 is configured to divide, based on attenuation coefficient values respectively corresponding to elements in an attenuation coefficient image, the elements into different attenuation coefficient intervals. The different attenuation coefficient intervals have different image contrasts. The adjustment module 3602 is configured to adjust, based on mapping functions respectively corresponding to the attenuation coefficient intervals, the attenuation coefficient value of the element in at least one attenuation coefficient interval. A slope of the mapping function of the attenuation coefficient interval with a minimum image contrast is greater than a slope of the mapping function of other attenuation coefficient interval. The first determination module 3603 is configured to obtain, based on adjusted attenuation coefficient values, a preprocessed image to be registered.

In an embodiment, the attenuation coefficient image processing device further includes: an allocation module configured to allocate a plurality of preset slopes to the respective attenuation coefficient intervals, respectively; and a second determination module configured to determine, based on the preset slopes of the respective attenuation coefficient intervals, the mapping functions.

In an embodiment, the attenuation coefficient image is taken as a motion image or a reference image, and at least two medical images to be registered include a first image to be registered as the motion image, and a second image to be registered as the reference image.

In an embodiment, the attenuation coefficient image processing device is provided, and the device further includes: a third determination module configured to determine, based on the first image to be registered and the second image to be registered, a target deformation field; and a fourth determination module configured to determine, based on the target deformation field and the attenuation coefficient image before preprocessing, a registered attenuation coefficient image.

In an embodiment, the fourth determination module includes: an obtaining unit configured to obtain first location information of a plurality of control points on the reference image; and a first determination unit configured to determine, based on an objective function, the first image to be registered, and the second image to be registered, the target deformation field; the objective function comprising the first location information of the plurality of control points.

In an embodiment, the first determination unit is further configured to iteratively optimize, based on the first image to be registered and the second image to be registered, the first location information of the plurality of control points to obtain second location information of the plurality of control points that meets a minimization of the objective function; and determine, based on the second location information of the plurality of control points and an interpolation algorithm, the target deformation field.

The specific features of the attenuation coefficient image processing device may be understood with reference to the features of the attenuation coefficient image processing method and will not be repeated here. The individual modules in the above attenuation coefficient image processing device can be implemented in whole or in part by software, hardware and combinations thereof. Each of the above modules may be embedded in hardware form or independent of a processor in a computer apparatus, or may be stored in software form on a memory in the computer apparatus so that the processor can be called to perform the operations corresponding to each of the above modules.

It should be understood that although the individual steps in the flow diagrams involved of the method embodiments as described above are shown sequentially as indicated by arrows, the steps are not necessarily performed sequentially in the order indicated by the arrows. Unless explicitly stated herein, the execution of these steps is not strictly limited in order and these steps can be performed in any other order. Moreover, at least some of the steps in the flow diagrams involved of the embodiments as described above may include a plurality of steps or a plurality of stages that are not necessarily performed at the same time, but may be performed at different times. The order in which these steps or stages are performed is not necessarily sequential, and these steps may be performed alternately or alternately with other steps or at least some of the steps or stages in other steps.

In an embodiment, a computer apparatus is provided. A diagram illustrating an internal configuration of the computer apparatus may be shown in FIG. 19. The computer apparatus includes a processor, a memory, a network interface connected via a system bus. The processor of the computer apparatus is configured to provide computing and control capabilities. The memory of the computer apparatus includes a non-transitory storage medium and an internal memory. The non-transitory storage medium stores operating systems, computer programs and databases. The internal memory provides an environment for the operation of the operating systems and the computer programs in the non-transitory storage medium. The database of the computer apparatus is configured to store medical image registration data. The network interface of the computer apparatus is configured to communicate with an external terminal via a network connection. The computer apparatus further includes an input/output interface, which is a connection circuit for exchanging information between the processor and external devices. The input and output interface are connected to the processor through a bus, referred to as an I/O interface.

It should be understood by a person of ordinary skill in the art that the configuration illustrated in FIG. 19, which is only a block diagram of part of the configuration related to the solution of the present disclosure, and does not constitute a limitation on the computer apparatus to which the solution of the present disclosure is applied. Specifically, the computer apparatus may include more or less components than those shown in the figure, or may combine some components, or may have a different arrangement of components.

In an embodiment, a seventh aspect of the present disclosure provides a computer apparatus, including a memory and a processor. The memory stores a computer program, and the processor, when executing the computer program, implements the steps in the method embodiments described above.

In an embodiment, an eighth aspect of the present disclosure provides a non-transitory computer-readable storage medium storing a computer program. The computer program, when executed by a processor, causes the processor to implement the steps in the method embodiments described above.

In an embodiment, a ninth aspect of the present disclosure provides a computer program product having a computer program stored therein. The computer program, when executed by a processor, causes the processor to implement the steps in the method embodiments described above.

A person of ordinary skill in the art may understand that implementation of all or part of the processes in the methods of the above embodiments may be completed by instructing the relevant hardware through a computer program. The computer program may be stored in a non-transitory computer-readable storage medium. When the computer program is executed, it may include the processes of the embodiments of the above methods. Any reference to memory, database or other medium used of the embodiments provided in the present disclosure may include at least one of a non-transitory and a transitory memory. The non-transitory memory may include a read-only memory (ROM), a magnetic tape, a floppy disk, a flash memory, an optical memory, or the like. The transitory memory may include a random-access memory (RAM) or an external cache memory, etc. As an illustration rather than a limitation, the random-access memory may be in various forms, such as a static random-access memory (SRAM) or a dynamic random-access memory (DRAM), etc.

In the following, further clauses are described to facilitate the understanding of the present disclosure.

Clause 1. A medical image registration method, including:
determining a similarity term and a regularization term in a voxel-based loss function used for medical image registration;
obtaining a similarity weight distribution and a regularization weight distribution;
adjusting, based on a similarity weight of each voxel contained in the similarity weight distribution, a contribution of a corresponding voxel in the similarity term to the loss function, the similarity weight of the voxel having a positive correlation relationship with a registration requirement accuracy associated with a region in which the voxel is located;
adjusting, based on a regularization weight of each voxel contained in the regularization weight distribution, a contribution of a corresponding voxel in the regularization term to the loss function, the regularization weight of the voxel having a negative correlation relationship with a degree of freedom of tissue deformation associated with a region in which the voxel is located; and
obtaining, based on an optimized loss function obtained by the adjustment, a target deformation field.

Clause 2. The method of clause 1, wherein obtaining the similarity weight distribution includes:
performing a region segmentation on a medical image to be registered to obtain at least two first-type regions; each of the first-type regions being associated with a corresponding registration requirement accuracy; and
determining, based on the registration requirement accuracy associated with the first-type region in which the voxel is located and the positive correlation relationship, the similarity weight of each voxel, and forming the similarity weight distribution.

Clause 3. The method of clause 2, wherein the at least two first-type regions include a lesion region and a non-lesion region, and the registration requirement accuracy associated with the lesion region is greater than the registration requirement accuracy associated with the non-lesion region.

Clause 4. The method of clause 1, wherein obtaining the regularization weight distribution includes:
performing a region segmentation on a medical image to be registered to obtain at least two second-type regions, each of the second-type regions being associated with a corresponding degree of freedom of the tissue deformation; and
determining, based on the degree of freedom of the deformation associated with the second-type region in which the voxel is located and the negative correlation relationship, the regularization weight of each voxel, and forming the regularization weight distribution.

Clause 5. The method of any one of clauses 2 to 4, wherein performing the region segmentation on the medical image to be registered includes:
determining a reference image among the at least two medical images to be registered; and
performing the region segmentation on the reference image.

Clause 6. The method of clause 1, wherein adjusting, based on the similarity weight of each voxel contained in the similarity weight distribution, the contribution of the corresponding voxel in the similarity term to the loss function includes:
determining, for each voxel, based on a pixel value of the voxel in a reference image and a pixel value of the voxel in a motion image after a deformation field acts, a pixel difference term of the voxel in the similarity term; and
assigning a corresponding similarity weight to the pixel difference term of each voxel.

Clause 7. The method of clause 1, wherein adjusting, based on the regularization weight of each voxel contained in the regularization weight distribution, the contribution of the corresponding voxel in the regularization term to the loss function includes:
determining, for each voxel, based on a gradient of a deformation field at the voxel in at least one spatial direction, a spatial gradient term of the voxel in the regularization term; and assigning a corresponding regularization weight to the spatial gradient term of each voxel.

Clause 8. A medical image registration device, including:
a loss function processing module configured to determine a similarity term and a regularization term in a voxel-based loss function used for medical image registration;
a weight distribution obtaining module configured to obtain a similarity weight distribution and a regularization weight distribution;
an adjustment module configured to adjust, based on a similarity weight of each voxel contained in the similarity weight distribution, a contribution of a corresponding voxel in the similarity term to the loss function, the similarity weight of the voxel having a positive correlation relationship with a registration requirement accuracy associated with a region in which the voxel is located; and adjust, based on a regularization weight of each voxel contained in the regularization weight distribution, a contribution of a corresponding voxel in the regularization term to the loss function, the regularization weight of the voxel having a negative correlation relationship with a degree of freedom of tissue deformation associated with a region in which the voxel is located; and
a deformation field obtaining module configured to obtain, based on an optimized loss function obtained by the adjustment, a target deformation field.

Clause 9. A computer apparatus including a processor and a memory storing a computer program, wherein when the processor executes the computer program, steps of the method of any one of clauses 1 to 7 are implemented.

Clause 10. A non-transitory computer-readable storage medium having a computer program stored therein, wherein when the computer program is executed by a processor, steps of the method of any one of clauses 1 to 7 are implemented.

Clause 11. A method for image registration based on a PET image, the method including:
selecting any one of a PET image and other medical image to perform a lesion region segmentation to obtain lesion regions;
determining, based on a size of the lesion region in which a lesion region voxel is located and a tracer concentration of the lesion region voxel in the PET image, a similarity weight of each lesion region voxel;
determining a similarity term in a voxel-based loss function used for medical image registration, and adjusting, based on the similarity weight of each lesion region voxel, a contribution of a corresponding voxel in the similarity term to the loss function to obtain an optimized loss function; and
obtaining, based on the optimized loss function, a deformation field between the PET image and the other medical image.

Clause 12. The method of clause 11, wherein determining, based on the size of the lesion region in which the lesion region voxel is located and the tracer concentration of the lesion region voxel in the PET image, the similarity weight of each lesion region voxel includes:
obtaining a negative correlation function; in the negative correlation function, a first independent variable and a second independent variable having a multiplication relationship, and the first independent variable and the second independent variable each having a negative correlation relationship with a dependent variable;
determining, based on a volume of the lesion region in which the lesion region voxel is located, a value of the first independent variable, and determining, based on a tracer concentration value of the lesion region voxel in the PET image, a value of the second independent variable; and
obtaining, based on a value of the dependent variable output by the negative correlation function, the similarity weight of the lesion region voxel.

Clause 13. The method of clause 12, wherein determining, based on the volume of the lesion region in which the lesion region voxel is located, the value of the first independent variable, and determining, based on the tracer concentration value of the lesion region voxel in the PET image, the value of the second independent variable, includes:
taking the lesion region in which the lesion region voxel is located as a target lesion region;
counting tracer concentration values of lesion region voxels in the target lesion region in the PET image to obtain a statistical value; and
taking a volume of the target lesion region as the value of the first independent variable, and taking the statistical value as the value of the second independent variable.

Clause 14. The method of clause 13, wherein counting the tracer concentration values of the lesion region voxels in the target lesion region in the PET image to obtain the statistical value, includes:
performing an average processing on the tracer concentration values of lesion region voxels in the target lesion region in the PET image to obtain an average value.

Clause 15. The method of clause 11, wherein the method further includes:
obtaining a set value that is smaller than the similarity weight of each lesion region voxel;
taking the set value as a similarity weight of a non-lesion region voxel; and
adjusting, based on the similarity weight of the non-lesion region voxel, a contribution of a corresponding voxel in the similarity term to the loss function.

Clause 16. The method of any one of clauses 11 to 15, wherein selecting any one of the PET image and the other medical image to perform the lesion region segmentation to obtain the lesion regions, includes:
selecting the PET image from the PET image and the other medical image to perform the lesion region segmentation to obtain the lesion regions.

Clause 17. The method of clause 16, wherein selecting the PET image to perform the lesion region segmentation to obtain the lesion regions includes:
obtaining a segmentation algorithm pre-built based on deep learning; and inputting the PET image into the segmentation algorithm to obtain the lesion regions.

Clause 18. The method of clause 17, wherein inputting the PET image into the segmentation algorithm to obtain the lesion regions includes:
obtaining, by inputting the PET image into the segmentation algorithm, a lesion distribution map output by the segmentation algorithm; and
processing, by using a connected region algorithm, the lesion distribution map to obtain the lesion regions which are independent with each other.

Clause 19. A device for image registration based on a PET image, the apparatus including:
a region segmentation module configured to select any one of a PET image and other medical image to perform a lesion region segmentation to obtain lesion regions;
a similarity weight obtaining module configured to determine, based on a size of the lesion region in which a lesion region voxel is located and a tracer concentration of the lesion region voxel in the PET image, a similarity weight of each lesion region voxel;
an adjustment module configured to determine a similarity term in a voxel-based loss function used for medical image registration, and adjust, based on the similarity weight of each lesion region voxel, a contribution of a corresponding voxel in the similarity term to the loss function to obtain an optimized loss function; and
a deformation field obtaining module configured to obtain, based on the optimized loss function, a deformation field between the PET image and the other medical image.

Clause 20. A computer apparatus including a processor and a memory storing a computer program, wherein when the processor executes the computer program, steps of the method of any one of clauses 11 to 18 are implemented.

Clause 21. An attenuation coefficient image processing method, including:
dividing, based on attenuation coefficient values respectively corresponding to voxels in an attenuation coefficient image, the voxels into different attenuation coefficient intervals, the different attenuation coefficient intervals having different image contrasts;
adjusting, based on mapping functions respectively corresponding to the attenuation coefficient intervals, the attenuation coefficient value of the voxel in at least one attenuation coefficient interval; a slope of the mapping function of the attenuation coefficient interval with a minimum image contrast being greater than a slope of the mapping function of other attenuation coefficient interval; and
obtaining, based on adjusted attenuation coefficient values, a preprocessed image to be registered.

Clause 22. The method of clause 21, further including:
allocating a plurality of preset slopes to the respective attenuation coefficient intervals, respectively; and
determining, based on the preset slopes of the respective attenuation coefficient intervals, the mapping functions.

Clause 23. The method of clause 21, wherein the attenuation coefficient image is taken as a motion image or a reference image, and at least two medical images to be registered include a first image to be registered as the motion image, and a second image to be registered as the reference image.

Clause 24. The method of clause 23, wherein after obtaining, based on the adjusted attenuation coefficient values, the preprocessed image to be registered, the method further includes:
determining, based on the first image to be registered and the second image to be registered, a target deformation field; and
determining, based on the target deformation field and the attenuation coefficient image before preprocessing, a registered attenuation coefficient image.

Clause 25. The method of clause 24, wherein determining, based on the first image to be registered and the second image to be registered, the target deformation field, includes:
obtaining first location information of a plurality of control points on the reference image; and
determining, based on an objective function, the first image to be registered, and the second image to be registered, the target deformation field; the objective function including the first location information of the plurality of control points.

Clause 26. The method of clause 25, wherein determining, based on the objective function, the first image to be registered, and the second image to be registered, the target deformation field, includes:
iteratively optimizing, based on the first image to be registered and the second image to be registered, the first location information of the plurality of control points to obtain second location information of the plurality of control points that meets a minimization of the objective function; and
determining, based on the second location information of the plurality of control points and an interpolation algorithm, the target deformation field.

Clause 27. An attenuation coefficient image processing device, including:
a division module configured to divide, based on attenuation coefficient values respectively corresponding to voxels in an attenuation coefficient image, the voxels into different attenuation coefficient intervals, the different attenuation coefficient intervals having different image contrasts;
an adjustment module configured to adjust, based on mapping functions respectively corresponding to the attenuation coefficient intervals, the attenuation coefficient value of the voxel in at least one attenuation coefficient interval, a slope of the mapping function of the attenuation coefficient interval with a minimum image contrast being greater than a slope of the mapping function of other attenuation coefficient interval; and
a first determination module configured to obtain, based on adjusted attenuation coefficient values, a preprocessed image to be registered.

Clause 28. A computer apparatus including a processor and a memory storing a computer program, wherein when the processor executes the computer program, steps of the method of any one of clauses 21 to 26 are implemented.

Clause 29. A non-transitory computer-readable storage medium having a computer program stored therein, wherein when the computer program is executed by a processor, steps of the method of any one of clauses 21 to 26 are implemented.

Clause 30. A computer program product including a computer program, wherein when the computer program is executed by a processor, steps of the method of any one of clauses 21 to 26 are implemented.

The technical features in the above embodiments may be combined arbitrarily. For concise description, not all possible combinations of the technical features in the above embodiments are described. However, provided that they do not conflict with each other, all combinations of the technical features are to be considered to be within the scope described in this specification.

The above-mentioned embodiments only describe several implementations of the present disclosure, and their description is specific and detailed, but should not be understood as a limitation on the patent scope of the present disclosure. It should be noted that, for a person of ordinary skill in the art may further make variations and improvements without departing from the conception of the present disclosure, and these all fall within the protection scope of the present disclosure. Therefore, the protection scope of the present disclosure should be subject to the appended claims.

What is claimed is:

1. A medical image registration method, comprising:
obtaining a similarity weight distribution containing a similarity weight of each element;
adjusting, based on the similarity weight of each element, a contribution of a corresponding element in a similarity term of a loss function to the loss function, the similarity weight of the element having a positive correlation relationship with a registration requirement accuracy associated with a region in which the element is located; and
obtaining, based on an optimized loss function obtained by the adjustment, a target deformation field.

2. The method of claim 1, further comprising:
obtaining a regularization weight distribution containing a regularization weight of each element; and
adjusting, based on the regularization weight of each element, a contribution of a corresponding element in a regularization term of the loss function to the loss function, the regularization weight of the element having a negative correlation relationship with a degree of freedom of tissue deformation associated with a region in which the element is located.

3. The method of claim 1, wherein obtaining the similarity weight distribution comprises:
performing a region segmentation on a medical image to be registered to obtain at least two first-type regions; each of the first-type regions being associated with a corresponding registration requirement accuracy; and
determining, based on the registration requirement accuracy associated with the first-type region in which the element is located and the positive correlation relationship, the similarity weight of each element, and forming the similarity weight distribution.

4. The method of claim 3, wherein the at least two first-type regions comprise a region of interest (ROI) and a non-ROI, and the registration requirement accuracy associated with the ROI is greater than the registration requirement accuracy associated with the non-ROI.

5. The method of claim 1, wherein obtaining the similarity weight distribution comprises:
performing a ROI segmentation on a medical image to be registered to obtain ROIs; the medical image to be registered being an image selected from a PET image and other medical image, and the other medical image being of the same or different modality as the PET image; and
determining, based on a size of the ROI in which a ROI element is located and a tracer concentration of the ROI element in the PET image, a similarity weight of each ROI element, and forming the similarity weight distribution.

6. The method of claim 5, wherein determining, based on the size of the ROI in which the ROI element is located and the tracer concentration of the ROI element in the PET image, the similarity weight of each ROI element comprises:
obtaining a negative correlation function; in the negative correlation function, a first independent variable and a second independent variable having a multiplication relationship, and the first independent variable and the second independent variable each having a negative correlation relationship with a dependent variable;
determining, based on a volume of the ROI in which the ROI element is located, a value of the first independent variable, and determining, based on a tracer concentration value of the ROI element in the PET image, a value of the second independent variable; and
obtaining, based on a value of the dependent variable output by the negative correlation function, the similarity weight of the ROI element.

7. The method of claim 6, wherein determining, based on the volume of the ROI in which the ROI element is located, the value of the first independent variable, and determining, based on the tracer concentration value of the ROI element in the PET image, the value of the second independent variable, comprises:
taking the ROI in which the ROI element is located as a target ROI;
counting tracer concentration values of ROI elements in the target ROI in the PET image to obtain a statistical value; and
taking a volume of the target ROI as the value of the first independent variable, and taking the statistical value as the value of the second independent variable.

8. The method of claim 7, wherein counting the tracer concentration values of the ROI elements in the target ROI in the PET image to obtain the statistical value, comprises:
performing an average processing on the tracer concentration values of ROI elements in the target ROI in the PET image to obtain an average value.

9. The method of claim 2, wherein obtaining the regularization weight distribution comprises:
performing a region segmentation on a medical image to be registered to obtain at least two second-type regions, each of the second-type regions being associated with a corresponding degree of freedom of the tissue deformation; and
determining, based on the degree of freedom of the deformation associated with the second-type region in which the element is located and the negative correlation relationship, the regularization weight of each element, and forming the regularization weight distribution.

10. The method of claim 3, wherein performing the region segmentation on the medical image to be registered comprises:
determining a reference image among the at least two medical images to be registered; and
performing the region segmentation on the reference image.

11. The method of claim 1, wherein adjusting, based on the similarity weight of each element, the contribution of the corresponding element in the similarity term of the loss function to the loss function comprises:
determining, for each element, based on a pixel value of the element in a reference image and a pixel value of the element in a motion image after a deformation field acts, a pixel difference term of the element in the similarity term; and
assigning a corresponding similarity weight to the pixel difference term of each element.

12. The method of claim 2, wherein adjusting, based on the regularization weight of each element, the contribution of the corresponding element in the regularization term of the loss function to the loss function comprises:
determining, for each element, based on a gradient of a deformation field at the element in at least one spatial direction, a spatial gradient term of the element in the regularization term; and
assigning a corresponding regularization weight to the spatial gradient term of each element.

13. The method of claim 5, wherein the method further comprises:
obtaining a set value that is smaller than the similarity weight of each ROI element;
taking the set value as a similarity weight of a non-ROI element; and
adjusting, based on the similarity weight of the non-ROI element, a contribution of a corresponding element in the similarity term to the loss function.

14. The method of claim 5, wherein performing the ROI segmentation on the medical image to be registered to obtain the ROIs, comprises:
selecting the PET image from the PET image and the other medical image to perform the ROI segmentation to obtain the ROIs.

15. The method of claim 14, wherein selecting the PET image to perform the ROI segmentation to obtain the ROIs comprises:
obtaining a segmentation algorithm pre-built based on deep learning; and
inputting the PET image into the segmentation algorithm to obtain the ROIs.

16. The method of claim 15, wherein inputting the PET image into the segmentation algorithm to obtain the ROIs comprises:
obtaining, by inputting the PET image into the segmentation algorithm, a ROI distribution map output by the segmentation algorithm; and
processing, by using a connected region algorithm, the ROI distribution map to obtain the ROIs which are independent with each other.

17. The method of claim 1, wherein in a case that a medical image to be registered is an attenuation coefficient image, the method further comprises:
dividing, based on attenuation coefficient values respectively corresponding to elements in an attenuation coefficient image, the elements into different attenuation coefficient intervals, the different attenuation coefficient intervals having different image contrasts;
adjusting, based on mapping functions respectively corresponding to the attenuation coefficient intervals, the attenuation coefficient value of the element in at least one attenuation coefficient interval; a slope of the mapping function of the attenuation coefficient interval with a minimum image contrast being greater than a slope of the mapping function of other attenuation coefficient interval; and
obtaining, based on adjusted attenuation coefficient values, a preprocessed medical image to be registered.

18. An attenuation coefficient image processing method, comprising:
dividing, based on attenuation coefficient values respectively corresponding to elements in an attenuation coefficient image, the elements into different attenuation coefficient intervals, the different attenuation coefficient intervals having different image contrasts;
adjusting, based on mapping functions respectively corresponding to the attenuation coefficient intervals, the attenuation coefficient value of the element in at least one attenuation coefficient interval; a slope of the mapping function of the attenuation coefficient interval with a minimum image contrast being greater than a slope of the mapping function of other attenuation coefficient interval; and
obtaining, based on adjusted attenuation coefficient values, a preprocessed medical image to be registered.

19. The method of claim 18, further comprising:
allocating a plurality of preset slopes to the respective attenuation coefficient intervals, respectively; and
determining, based on the preset slopes of the respective attenuation coefficient intervals, the mapping functions.

20. A computer apparatus comprising a processor and a memory storing a computer program, wherein the processor, when executing the computer program, implements:
obtaining a similarity weight distribution containing a similarity weight of each element;
adjusting, based on the similarity weight of each element, a contribution of a corresponding element in a similarity term of a loss function to the loss function, the similarity weight of the element having a positive correlation relationship with a registration requirement accuracy associated with a region in which the element is located; and
obtaining, based on an optimized loss function obtained by the adjustment, a target deformation field.
